(19) United States
(12) Patent Application Publication
(10) Pub. No.: US 2025/0184815 A1
(43) Pub. Date: Jun. 5, 2025

(54) APPARATUS AND METHODS OF USING HEADERS FOR CONTROLLING NODES IN A COMMUNICATION SYSTEM

(71) Applicant: Analog Devices International Unlimited Company, Limerick (IE)

(72) Inventors: Isaac Molina Hernandez, Valencia (ES); Seamus Anthony Ryan, Nenagh (IE)

(21) Appl. No.: 18/965,964

(22) Filed: Dec. 2, 2024

Related U.S. Application Data
(60) Provisional application No. 63/605,834, filed on Dec. 4, 2023.

(51) Int. Cl. H04W 28/06; H04L 69/22

(52) U.S. Cl. CPC H04W 28/06; H04L 69/22

(57) ABSTRACT

In an aspect, a communication method is provided. The method includes receiving a message including a header field of an information structure configured with one or more headers to control at least one of an execution of at least one command specified in the information structure or a delivery of a response to at least one of the execution of the at least one command or a receipt of the information structure.

### CLAIM OF PRIORITY

The present application claims priority to U.S. Provisional Application No. 63/605,834, filed on Dec. 4, 2023, and hereby incorporated herein by reference.

### TECHNICAL FIELD

Aspects of the present disclosure relate generally to information technology and, more particularly, to headers in information structures such as messages, data packets, and so forth that include headers and payloads.

### BACKGROUND

To maintain control and proper management of information structures such as messages, data packets, and so forth, various portions of the information structures are assigned various functions. For example, a header portion (or “header” in short) may provide initial information preceding a payload portion (or “payload” in short) that typically carries the message and/or data part of an information structure. The header may include, for example, routing or other information used in receiving and/or processing the data in the payload. The header may be included in a command message used to inform a remote node to perform a specific task.

However, there is a need for an improved approach to using headers in information structures in communication protocols, including in Ethernet communications, such as but not limited Ethernet to Edge Bus (E2B) communication protocols.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

In an aspect, a communication method is provided at a receiving node of a communication system. In an aspect, the method includes receiving a message including a header field of an information structure configured with one or more headers to control at least one of an execution of at least one command specified in the information structure or a delivery of a response to at least one of the execution of the at least one command or a receipt of the information structure.

The present disclosure includes a computer-readable medium (e.g., a non-transitory computer-readable medium) having instructions executable by a processor to perform the described methods.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which.

FIG. 1 is a block diagram of an exemplary communication system in which one or more information structures are used, in accordance with an exemplary aspect.

FIG. 2 is a block diagram of an example information structure, in accordance with an exemplary aspect.

FIG. 3 is a diagram of an exemplary command message, in accordance with an exemplary aspect.

FIG. 4 is a diagram of a HEADER_LIST field of a header, in accordance with an exemplary aspect.

FIGS. 5-6 are block diagrams of various headers, fields, and subfields, in accordance with an exemplary aspect.

FIG. 7 is a timing diagram of command execution and command response, in accordance with an exemplary aspect.

FIG. 8 is a flow diagram of an example communication method, in accordance with an exemplary aspect.

FIGS. 9-15 are flow diagrams of further example steps of the method of FIG. 6, in accordance with an exemplary aspect.

FIG. 16 is a block diagram of an example communication system having an Electronic Controller Unit (ECU) and a set of remote nodes, in accordance with an example aspect;

FIG. 17 is a diagram of examples of the ECU and set of nodes of FIG. 16, in accordance with an example aspect.

FIG. 18 is a diagram of an example NACK_STREAM command payload, in accordance with an exemplary aspect.

FIG. 19 is a diagram of an example E2B_NACK_STREAM message, in accordance with an exemplary aspect.

FIG. 20 is a diagram of an example ACK_MAILBOX command payload, in accordance with an exemplary aspect.

FIG. 21 is a diagram of an example E2B_ACK_MAILBOX message, in accordance with an exemplary aspect.

FIG. 22 is a diagram of an example command and response data flow, in accordance with an exemplary aspect.

FIGS. 23 and 24 are diagrams of an example brief 0x05 COMMAND message and a single 0x05 COMMAND message, in accordance with exemplary aspects.

FIG. 25 is a diagram of exemplary rslt field values, in accordance with an exemplary aspect.

FIGS. 26 and 27 are diagrams of an example brief 0x06 RESPONSE message and a single 0x06 RESPONSE message, in accordance with exemplary aspects.

FIG. 28 is a diagram of exemplary trigger configuration values, in accordance with an exemplary aspect.

FIG. 29 is a diagram of exemplary trigger command settings on demand, in accordance with an exemplary aspect.

FIG. 30 is a diagram of exemplary trigger command settings on time stamp execute, in accordance with an exemplary aspect.

FIG. 31 is a diagram of exemplary trigger command settings on timestamp discard, in accordance with an exemplary aspect.

FIG. 32 is a diagram of exemplary trigger command settings on timestamp timebase are shown, in accordance with an exemplary aspect.

FIG. 33 is a diagram of exemplary trigger command settings on timestamp discard, in accordance with an exemplary aspect.

FIG. 34 is a diagram of exemplary op field values, in accordance with an exemplary aspect.

FIG. 35 is a diagram of exemplary trigger command settings on command, in accordance with an exemplary aspect.

FIG. 36 is a diagram of exemplary trigger command settings on timestamp discard, in accordance with an exemplary aspect.

FIG. 37 is a diagram of an example computing environment, in accordance with an exemplary aspect.

### DETAILED DESCRIPTION

The present disclosure is directed to a communication system and messages having headers in information structures that include headers and payloads.

In an aspect, the information structures include, but are not limited to, messages, data packets, and so forth that include headers and payloads.

Aspects of the present disclosure are directed to communications using headers that are configured to control at least one of an execution of at least one command specified in the information structure and a delivery of a response to at least one of the execution of the at least one command or a receipt of the information structure.

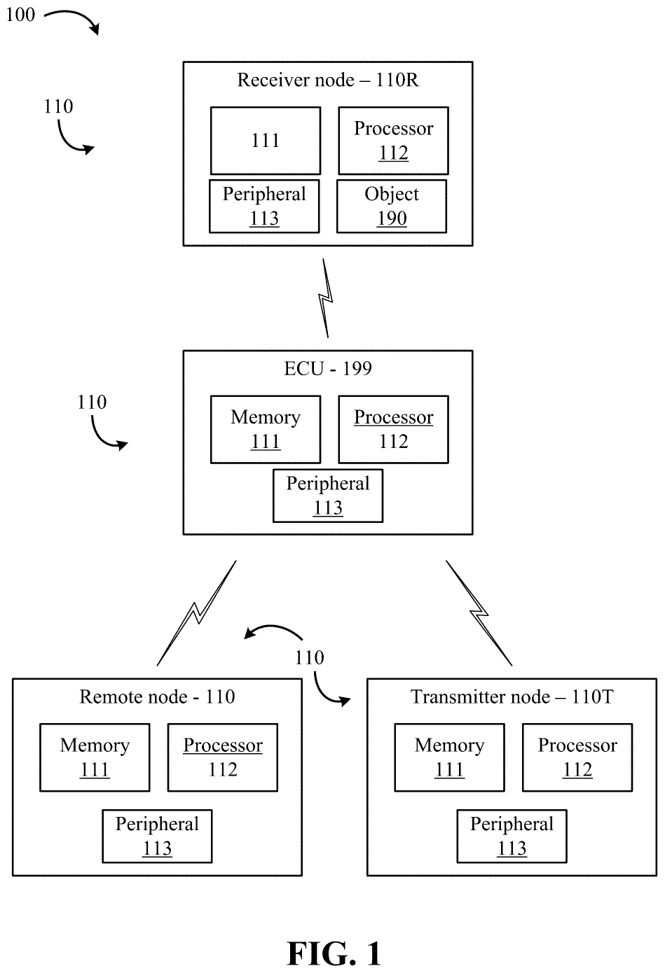

Referring to FIG. 1, an exemplary communication system 100 is shown, in accordance with an example aspect.

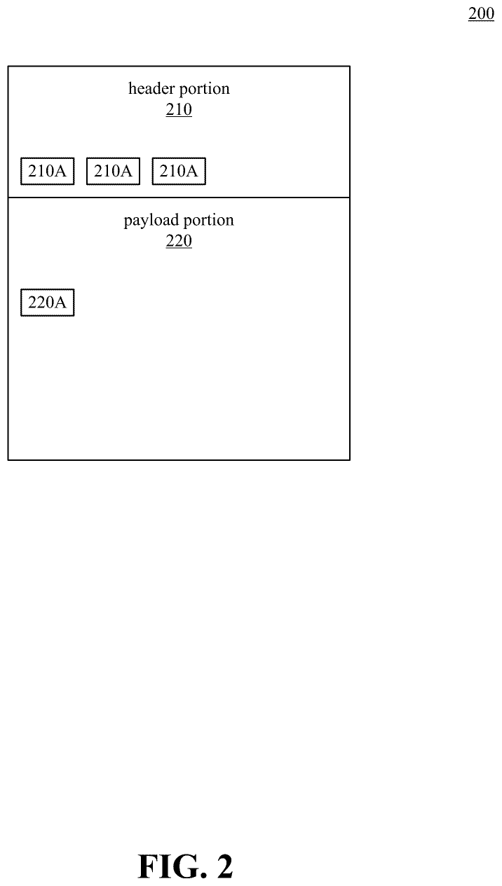

The communication system 100 includes a set of nodes 110 and an Electronic Control Unit (ECU) 199. Each of the nodes 110 and the ECU 199 may include one or more processors 111 for processing messages and executing program code including commands in headers, one or more memories 112 operatively coupled to the one or more processors for storing the messages and/or the program code, and a transceiver 113 for transmitting information structures 200 (as shown in FIG. 2) to other nodes 110 and/or ECU 199 and/or other entities and receiving information structures 200 from other nodes 110 and/or ECU 199 and/or other entities.

In an aspect, there is, at a given time, at least one transmitter node 110T and at least one receiver node 110R among the set of nodes 110. In an aspect, the at least one transmitter node 110T transmits an information structure 200 (as shown in FIG. 2) to the at least one receiver node 110R. The receiver node 110R then acts upon information including in the information structure 200 including the header portion 210 and/or payload portion 220 of the information structure 200. Acting upon the information included in the information structure 200 can involve controlling an object 190 such as a robot, a vehicle, a toy, an appliance, and so forth. The preceding listing of objects 190 is merely illustrative and the controlling of an object 190 can involve any object controlled by control signals received via a communication element (e.g., a wire, an antenna, a transceiver, etc.). In an aspect, the object 190 is included in or includes a node 110. In other aspects, wired connections are used in place of wireless.

In the example of FIG. 1, the ECU node 110 is intermediate to the transmitter node 110T and the receiver node 110R and thus acts as both a receiver node initially and then a transmitter node 110T thereafter for a given information structure communication. In an aspect, the ECU node 110 takes sensor data from receiver node 110R and analyzes the sensor data for a course of action for receiver node 110R, which may be a movable device such as but not limited to a robot or a vehicle. For example, the sensor data may indicate a potential collision if corrective action is not taken, and the ECU node 110 may analyze the sensor data to determine the corrective action and provide the corrective action as instructions to the receiver node 110R to follow. In another scenario, sensor data may indicate two locations between which objects are exchanged (e.g., an assembly line). The preceding are merely illustrative examples, and other actions may be performed by the receiver node 110R in response to instructions from ECU node 110 or another node (e.g., a sensor node having its own ECU to both identify issues and determines way to correct the issues as instructions for transmitting to the receiver node 110R.

Referring to FIG. 2, an exemplary information structure 200 is shown, in accordance with an exemplary aspect.

The information structure 200 includes a header portion 210 and a payload portion 220. The header portion 210 includes one or more headers 210A. A header 210A describes information placed in front of other data, known as the body or payload 120A. The header describes the payload and information to help nodes know how the data should be handled. The payload portion 220 includes a payload 220A of the information structure. As an example, the payload portion 220 may include one or more of: data; metadata; one or more commands; message content; and so forth.

Each of the one or more headers 210A is configured to control at least one of an execution of at least one command specified in the information structure and a delivery of a response to at least one of the execution of the at least one command and a receipt of the information structure. To that end, each of the one or more headers 210A includes fields for specifying related information such as an implicated command, a time for a time delay, a time of command execution, and so forth, depending on the header function.

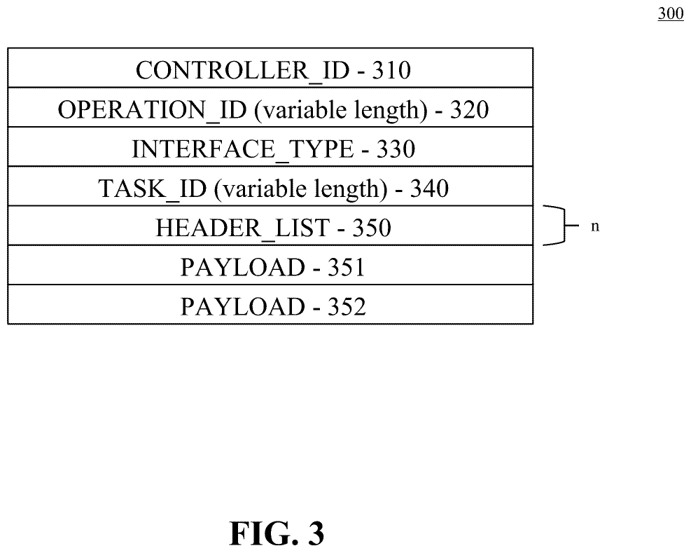

Referring to FIG. 3, an exemplary command message 300 is shown, in accordance with an exemplary aspect.

The command message 300 includes a controller_id field 310, an operation_id field 320, an interface_type_id field 330, a header_list field 350, and a first payload field 351 and a second payload field 352.

The controller_id field 310 is used to identify the sender of the command uniquely across the network. The network administrator must make sure no two devices use the same controller_id.

The operation_id field 320 is used as a handle to the command, together with controller_id. The sender must make sure handles are not reused until the command completes the execution. Typically, the operation_id field 320 can be a number that keeps increasing.

The interface_type_id field 330 is used to ensure compatibility between the sender and receiver as the interface_type_id field 330 indicates the type of interface the message is meant for. Each value of interface_type_id corresponds to a different interface type, like Serial Peripheral Interface (SPI), Inter-Integrated Circuit (I2C), Universal Asynchronous Receiver/Transmitter (UART), etc.

The following example values may be used for the interface_type_id field 330:

| Value | Name |
|:-: |:-----------------------:|
| 0 | Serial Peripheral Interface (SPI) |
| 1 | Inter-Integrated Circuit (I2C) |
| 2 | Local Interconnect Network (LIN) |
| 3 | Universal Asynchronous Receiver/Transmitter (UART) |
| 4 | Motor |
| 5 | General Purpose Input Output (GPIO) |
| 6 | Voltage monitor |
| 7 | Tachometer |
| 8 | Generic |
| 9-192 | Reserved|
| 193-255 | Customer specific header |

The task_id field 340 identifies the specific task. The task_id field 340 acts as a unique identifier, linking the message to a predefined task within the interface. The value assigned to task_id corresponds to a particular action that the system recognizes and is programmed to execute upon receiving the message.

The header_list field 350 represents an array of headers included in the message, where n denotes a number of header fields.

The payload field 351, 352 includes the data payload associated with the message. It is to be appreciated that there may be more than one payload field. In an aspect, each payload field corresponds to a respective header. In an aspect, a header field may include more than one payload field. For example, there may be a data payload field and a metadata payload field for a given (i.e., the same) header. These and other variations are contemplated by the present disclosure.

A further description will now be given regarding the header_list field

### Header List

In an aspect, a message such as, e.g., an Ethernet to Edge Bus (E2B) message, includes one or more headers 210A. The headers 210A provide extra settings for a message such as timestamped execution, delay, or safety configurations. The message ends with a payload identifier and an actual payload.

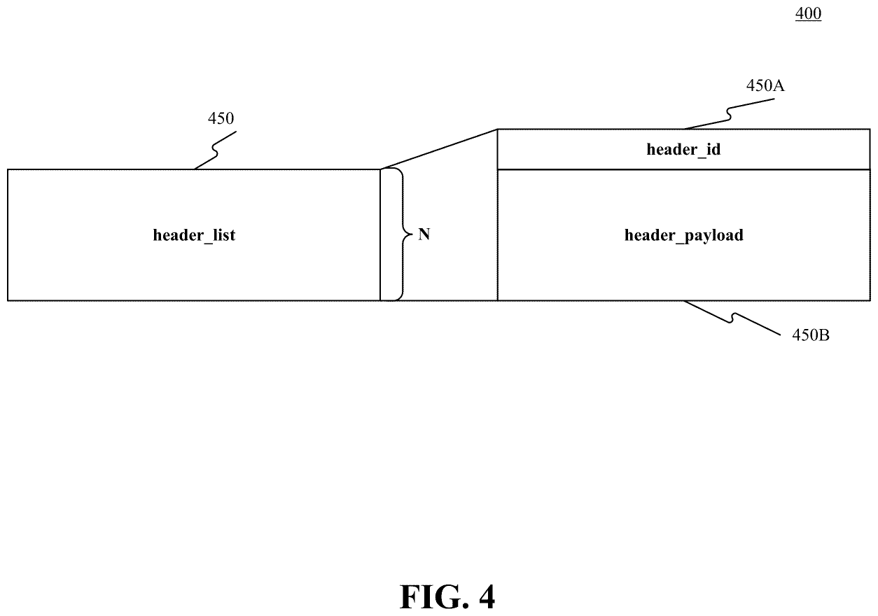

Referring to FIG. 4, an exemplary header_list field 450 of the command message 400 of FIG. 3 is shown, in accordance with an example aspect. The command message 400 may be transmitted in communication system 100 of FIG. 1.

The header_list field 450 lists all the headers of a particular message by identification (id) number and also includes the payloads of all the headers themselves.

The header_list field 450 includes a header_id subfield 450A and a header_payload subfield 450B. The header_id subfield 450A specifies a particular header number as an id number. The header_payload subfield 450B corresponds to a particular header_id subfield 450A (and id number) and specifies the payload for a particular header corresponding to the particular header_id subfield 450A.

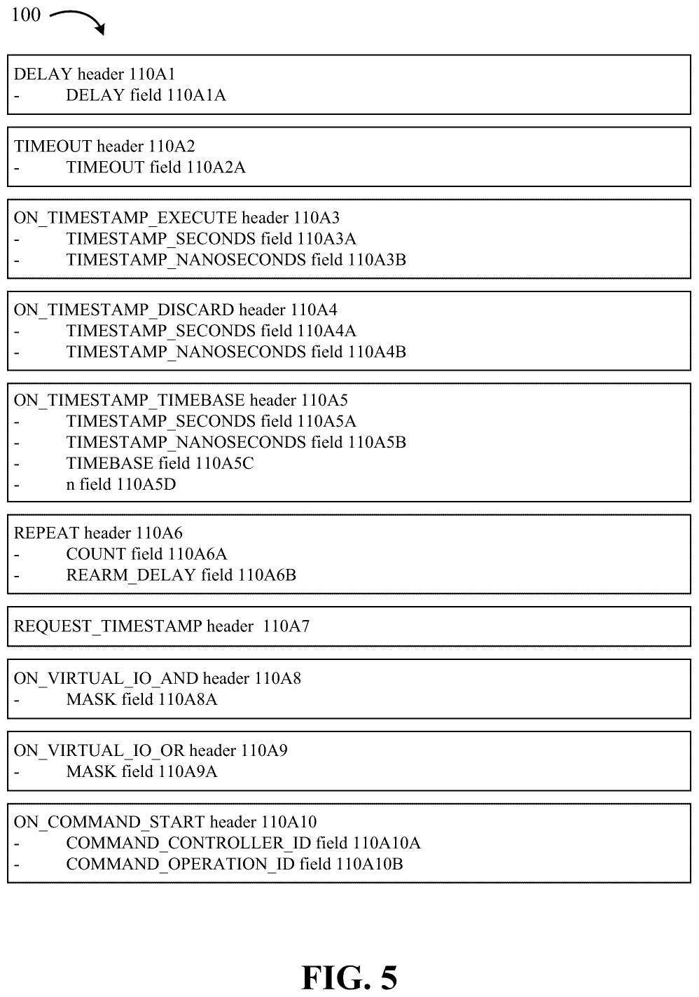

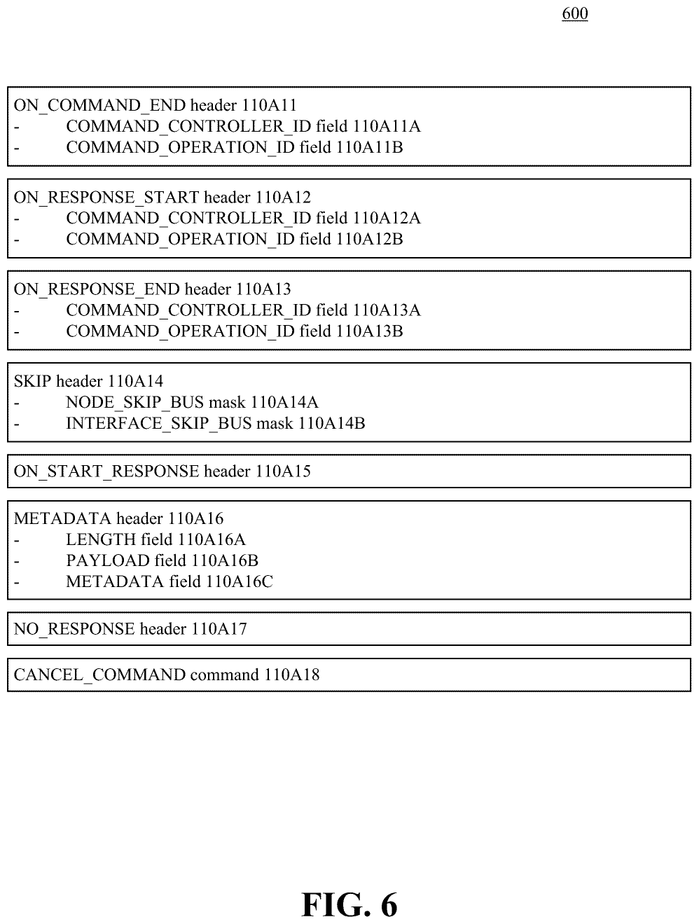

Referring to FIGS. 5-6, various headers, fields, and subfields are shown, in accordance with various example aspects. The fields and subfields correspond to the headers and are used to support the functionality of the headers.

It is to be appreciated that the headers and corresponding fields and subfields can be included in E2B messages or other messages along with other types of data/information that is conveyed in the header portion 210 or payload portion 220 of the information structure 200 (FIG. 2). The other types of data/information may include one or more of a timestamp(s), a command identifier(s), an interface identifier(s), an interface type(s), a sequence number(s), a task identifier(s), a checksum(s), a message version(s), a message type(s), a message topic(s), a command topic(s), SYNC information, a result(s), a message length, a message format (BRIEF, etc.), reserved, MB, TV, a payload(s) 120A, and so forth. The preceding other types of data/information may be implemented as fields and/or subfields of a message.

The following may apply regarding some of the preceding other types of data/information:
topic: Topics are indexed buses over which interfaces can publish messages. When an interface sends a message, the interface publishes on a topic. When a listener or ECU receives a message, the listener or ECU subscribes to a topic.
interface_type_id: This field contains the interface_type_id of the source of the notification. Together, with notification_type_id, helps to identify the schema of the notification.
notification_type_id: The field serves as a unique identifier for each notification type generated by an interface. Together, with interface_type_id, helps to identify the schema of the notification.
MB: This field is designed to indicate the system that this notification is critical, requesting an acknowledge of the notification.
TV: This flag serves as an indicator of the presence of the associated timestamp field in the message. When set to true, it signifies that the timestamp is present and valid and accurately represents the time of the creation of the notification. Conversely, if the flag is set to false, it implies that the timestamp is not present in the response.
timestamp: This field indicates the specific point in time until which the notification was created. It consists of two 32-bit variables: The first four bytes representing seconds and the last four bytes representing nanoseconds. It is an optional field that is only present if the TV field is set true.
payload: This field carries the actual content of the notification. The structure and data type of this field are determined by two key factors: the interface_type_id and the notification_type_id fields.

Some headers may include a mask field.
mask: The mask serves as a bit-wise selector that determines which bits in the virtual input bus are relevant for the logical operation.
AND operation: The mask singles out specific bits; the output is true only if all these selected bits are 1. If any of the selected bits is 0, the output will be false.
OR operation: The mask is used to identify certain bits; the output is true if at least one of these selected bits is 1. The output is false only if all the selected bits are 0.

Some headers include one or more timestamp fields. For example, in some aspects, headers may include a single timestamp field with the first four bytes corresponding to a first time unit (e.g., seconds), and the second four bytes corresponding to a second time unit (e.g., nanoseconds). In other aspects, two or more timestamps may be used. For example, a timestamp_seconds field indicates time in seconds, and a timestamp_nanoseconds field indicates time in nanoseconds. Together, a particular time in seconds and nanoseconds can be derived for various purposes as described in further detail hereinbelow.

A description will now be given of various different headers and their fields and subfields.

### DELAY Header 210A1

The presence of the delay header 210al indicates that the message includes a delay field 210A1A specifying a nanosecond (or other unit of time) delay between command reception and command execution by the processing unit. The value entered into the delay field 210A1 A represents the exact duration that the system should wait before processing (executing) the received command.

### Delay Header Example

The ECU needs to run two commands with a 50 ms gap between the two commands. To do this, the ECU adds the delay header 210A1 to the second command. This tells the system to wait 50 ms after the command arrives at the ECU interface before the ECU starts running the second command, while the first command will be immediately executed.

### TIMEOUT Header 210A2

The timeout header 210A2 specifies the maximum duration allowed between the moment a command is queued for execution in a node and when the command is executed. Upon message receipt, the node stores the message in its execution queue and countdown begins as per the timeout duration specified in a timeout field 110A2A. If the command is not executed within this timeframe, then the node discards the message, generating a response whose result field is set to “timeout”.

The TIMEOUT field 210A2 specifies the maximum time in nanoseconds (or other unit of time) between when a command is queued for execution in a node and when the command is actually executed.

### Timeout Header Example

### Example A

The ECU wants to execute a command, but the command needs to be executed in less than 50 ms or an error message response will be received. The ECU sets the TIMEOUT header 210A2 to 50 ms.
a. If the node is able to execute the command in time, nothing happens.
b. If the node is unable for any reason to execute the command in time, a timeout response is generated, and the command is cancelled.

### Example B

In a scenario where there is time synchronization, the ECU wants to execute a command, but the command needs to be executed earlier than a particular time A or an error response is generated. The ECU sets the timeout header 210A2 to include the timestamp A.
a. If the node is able to execute the command in time, nothing happens.
b. If the node is unable for any reason to execute the command in time, a timeout response is generated, and the command is cancelled.

### ON_TIMESTAMP_EXECUTE Header 210A3

The on_timestamp_execute header 210A3 is designed to execute commands based on a specific future timestamp, ensuring that actions are carried out at designated times. The on_timestamp_execute header 210A3 works by monitoring the current time against a timestamp in a timestamp field 210A3A and/or 210A3B When the system clock aligns with the value in the timestamp field 210A3A and/or 210A3B, the command is executed.

In cases where the specified timestamp is already in the past at the time of processing, instead of discarding the command, the system executes the command immediately.

A timestamp_seconds field 210A3A indicates the seconds of the specific point in time until which the command needs to be executed.

A timestamp_nanoseconds field 210A3B indicates the nanoseconds of the specific point in time until which the command needs to be executed.

### ON_TIMESTAMP_EXECUTE Header Example

In a time synchronized system, the ECI wants to execute a command at a timestamp A.
a. If timestamp A is in the future when the command is received, the interface waits until time A before executing the command.
b. If timestamp A is in the past when the command is received, the interface executes the command immediately.

### ON_TIMESTAMP_DISCARD Header 210A4

The on_timestamp_discard header 210A4B is designed to execute commands based on a specific future timestamp, ensuring that actions are carried out at designated times. The on_timestamp_discard header 210A4 works by monitoring the current time against a timestamp in a timestamp field 210A4A and/or 210A4B. When the system clock aligns with this timestamp, the command is executed.

However, if the timestamp for a command is already in the past at the time of the processing, at the time of processing, the command is automatically discarded. This ensures that the system does not execute outdated or irrelevant commands.

A timestamp_seconds 210A4A field indicates the seconds of the specific point in time until which the command needs to be executed.

A timestamp_nanoseconds 210A4B field indicates the nanoseconds of the specific point in time until which the command needs to be executed.

### ON_TIMESTAMP_DISCARD Header Example

In a time synchronized system, the ECU wants to execute a command at a timestamp A.
a. If timestamp A is in the future when the command is received, the interface waits until time A before executing the command.
b. If timestamp A is in the past when the command is received, the interface discards the command and does not execute the command.
   ON_TIMESTAMP_TIMEBASE header 210A5

The on_timestamp_timebase header 210A5 is designed to execute commands based on the formula “‘timestamp’+n*‘timebase.’” The on_timestamp_timebase header 210A5 is a trigger where a specific point in time (timestamp) servers as the reference, a fixed time interval (timebase) determines the periodicity, and an arbitrary multiplier (n) indicates when the trigger activates.

The trigger activation time is the point in time when the trigger becomes active for the first time.

A timestamp_seconds 210A5A field indicates the seconds of the starting specific point in time until which the command needs to be executed.

A timestamp_nanoseconds field 210A5B indicates the nanoseconds of the starting specific point in time until which the commands needs to be executed.

A timebase field 210A5C indicates a fixed interval of time, which determines the periodicity or frequency of the trigger's activation. This time can be defined in nanoseconds or other time unit.

An n field 210A5D indicates an arbitrary multiplier.

### Timebase Example

In a time synchronized system, some actuators can only be enabled during a periodic window. The ECU wants to execute a command at a particular timestamp A. However, if the timestamp is in the past, rather than rejecting or executing the command the ECU will search for the next periodic point from time A that is valid for execution.

The system has an actuator that can only be enabled once every 50 ms. The ECU decides that the valve must open at timestamp A, however, network delays force the message to arrive to the interface 70 ms later. The interface will then open the valve at timepoint A (timestamp)+2*50 ms (timebase).

### REPEAT Header 210A6

The repeat header 210A6 controls the automatic repetition of a command.

A count field 210A6A indicates the number of times an execution of the command should be repeated. A value of 0 represents an infinite number of execution repeats, until the command is cancelled by the user.

A rearm_delay field 210A6B sets a rearm delay time to define a delay, e.g., a time duration, to prevent immediate re-triggering of the command, ensuring sufficient gap between consecutive activations. This time can be defined in nanoseconds or other time unit.

### Repeat Example

The ECU wants to blink an LED every 250 ms for 10 times.

The ECU adds a count field 210A6A whose count is 10 and the rearm_delay field 210A6B is set to 250 ms. Upon reception of the command, the payload will be executed exactly 10 times, with a spacing between start of executions of 250 ms.

The repeat header 210A6 can be combined with the on_timestamp_timebase header 210A5 for more complex trigger schemes.

### REQUEST_TIMESTAMP Header 210A7

The request_timestamp header 210A7 specifies whether the response produced by the command should include a timestamp. The timestamp reflects the time when the response was generated.

### REQUEST_TIMESTAMP Header Example

The ECU wants the remote node to timestamp when the command was executed.

The ECU can do so by adding the request_timestamp header 210A7, the response will now include the acquisition timestamp.

### ON_VIRTUAL_IO_AND Header 210A8

The concept of a Virtual Input refers to abstracts of IO interfaces, such as General Purpose Input/Output (GPIO) ports or other signal sources such as interrupts, timers, or internal buses. Virtualizing these signals means they can be used by the interface trigger subsystem. For example, an internal virtual input connected to the safe mode of the device can be used to trigger the execution of a command, only when the system is in safe mode.

In on_virtual_io_and mode, the output is true only if all the selected bits (as determined by a mask) in the virtual input bus are true (1). This operation is analogous to a series of interconnected switches, where every selected switch must be on for the circuit to activate.

A mask field 210A8A serves as a bit-wise selector that determines which bits in the virtual input bus are relevant for the logical operation. The mask singles out specific bits. The output is true only if all these selected bits are 1. If any of the selected bits is 0, then the output will be false.

### ON_VIRTUAL_IO_OR Header 210A9

The concept of a virtual input refers to an abstraction of input/output (I/O) interfaces, such as General Purpose Input/Output (GPIO) ports or other signal sources such as interrupts, timers, or internal buses. Virtualizing these signals means they can be used by the interface trigger subsystem. For example, an internal virtual input connected to the safe mode of the device can be used to trigger the execution of a command, only when the system is in safe mode.

In on_virtual_io_or mode, the output is true if any of the selected bits (as determined by the mask) in the virtual input bus are true (1). This is similar to having parallel switches, where activating any of the selected switches turns on the circuit.

A mask field 210A9A serves as a bit-wise selector that determines which bits in the virtual input bus are relevant for the logical operation. The mask is used to identify certain bits. The output is true if at least one of these selected bits is 1. The output is false only if all the selected bits are 0.

### VIRTUAL_IO_HEADERS (AND/OR) Examples

The ECU might want that some commands are executed when a GPIO toggles. This virtual IO header expands the concept by allowing also internal signals to trigger commands. The signals that are connected to the virtual_io bus depend on the remote node. These signals can also include bits from the register map, or internal signals like flags or error interrupts.

The ECU wants to execute a command exactly when the device is GPTP synchronized and a GPIO is set true.
1. The ECU adds a VIRTUAL_IO_AND header 210A8 to the command, setting the corresponding bits for GPTP synchronized and GPIO[3] to true.
2. The interface will wait until both conditions are met, and then execute the command.

Alternatively, the ECU could require that either one of the two conditions is met. In this case, instead of using a virtual_io_and header 210A8, the ECU would be using a virtual_io_or header 210A9.

### ON_COMMAND_START Header 110A10

The presence of the on_command_start 210A10 header indicates that a command is executed at the beginning of an execution of another command. The on_command_start header 210A10 is used to execute commands in synchrony.

A command_controller_id field 210A10A specifies a command's controller_id value used to execute the current command. In an aspect, the controller_id value specifies a particular controller from among a plurality of controllers.

A command_operation_id field 210A10B specifies a command's operation_id value used to execute the current command. In an aspect, the operation_id value specifies a particular operation from among a plurality of operations.

### ON_COMMAND_END Header 210A11

The presence of the on_command_end header 210A11 indicates that a command is executed at the end of an execution of another command. The on_command_end header is used to execute a command immediately after another command's completion.

A command_controller_id field 210A11A specifies which command's controller_id value is used to execute the current command. In an aspect, the controller_id value identifies a particular controller from among a one or more controllers.

A command_operation_id field 210A11B specifies which command's operation_id value needs to be monitored to trigger the execution of the current command. In an aspect, the operation_id value identifies a particular operation from among one or more controllers.

### ON_RESPONSE_START Header 210A12

The presence of the on_response_start header 210A12′ indicates that the command should trigger (another) command at the beginning of a response. The on_response_start header 210A12 is used to execute commands in synchrony to responses.

A command_controller_id field 210A12A specifies which command's controller_id needs to be monitored to trigger the execution of the current command.

A command_operation_id field 210A12B specifies which command's operation_id needs to be monitored to trigger the execution of the current command.

### ON_RESPONSE_END Header 210A13

The presence of the on_response_end header 210A13 indicates the command should trigger another command at the conclusion of a response. the on_response_end header 210A13 is used to initiate follow-up commands once a response has been fully delivered.

A command_controller_id field 210A13A specifies the command's controller id that needs to be monitored to trigger the execution of the current command.

A command_operation_id field 210A13B specifies which command's operation_id needs to be monitored to trigger the execution of the current command.

### ON_[COMMAND|RESPONSE]_[START|END] Headers 110A10, 210A11, 210A12, and 210A13

A set of the two fields controller_id 210A10A, 210A11A, 210A12A, and 210A13A and operation_id 210A10B, 210A11B, 210A12B, and 210A13B can identify a message including a command in a remote node.

There are four trigger points during the execution of a command. The four trigger points are really dependent on the interface itself.

In this case, the ECU wants to trigger a command after a previous one. In this case, the ECU will add the on_command_end_header 210A11 with the controller_id 110A11A and operation_id 110A11B of the previous command.

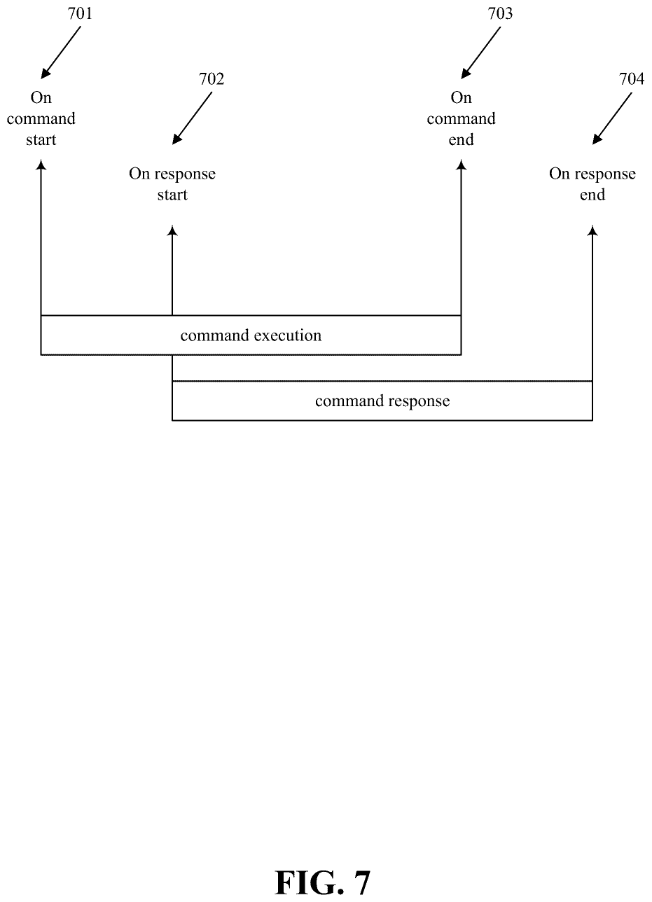

Referring to FIG. 7, command execution and command response are shown, in accordance with an example aspect.

Command execution involves command start 701 and command end 703 and response start 702 and response end 704. In many cases, the response start 702 precedes the command end 703. In other cases, the response start 702 could follow the command end 703 (now shown). The aspects of the present disclosure can be applied to any of these cases.

### SKIP Header 210A14

The skip functionality is designed to control message processing using bit-wise masks and virtual skip buses. For each bus, a node_skip_bus mask 210A14A and an interface_skip_bus mask 210A14B specifies which bits to check. For each high bit in the mask, if the corresponding bit in a bus is high (1), the current message is skipped. If the bit is low (0), the message is processed. This allows for selective message handling at both the node and interface levels.

The functionality of the node_skip_bus mask 210A14A is specific to each implementation and may include features such as safe modes tailored to the particular requirements of the node operations.

Similarly, the interface_skip_bus mask 210A14B is also tailored to the specifics of each implementation, with additional considerations for the unique aspects of the interface the interface_skip_bus mask 210A14B operates on. For instance, in an I2C interface, this could involve handling scenarios like a non-acknowledge signal.

When a message is skipped, the interface generates a linked message whose result field is set to skipped.

node_skip_bus mask 210A14A is a mask at the node level that determines message skipping based on a bit-wise mask, where a high bit results in the associated message being skipped.

interface_skip_bus mask 210A14B is a mask at the interface level that determines message skipping based on a bit-wise mask, where a high bit results in the associated message being skipped.

### Skip Header Example

The interface can have multiple skip buses whose flags are generated by different modules or cores from the remote node. As an example, we have two, the node_skip_bus mask 210A14A and the interface_skip_bus mask 210A14B.

The node_skip_bus mask 210A14A has top level flags such as, for example, a time synchronization locked flag, a safety mode active flag, a safety mode not-active flag or others. The interface_skip_bus mask 210A14B in an I2C interface could have flags like device non-acknowledge and data non-acknowledge.

The ECU wants to execute a command, but only if the node is not in safety mode. For this case, the ECU will set the bit corresponding to the safety mode not-active flag to true (1). Upon triggering the command, if the flag is set, the command will not be executed and a response with result code SKIP generated.

It is to be appreciated that there can be many different flags and conditions coming from different blocks. The idea behind the SKIP header is to execute commands conditionally to the status of the node.

### ON_START_RESPONSE Header 210A15

An interface may also need some time to fully execute a command prior to generating a response. As an optional feature, the on_start_response header 210A15 specifies whether the interface is obligated to produce a response without any content (essentially, an empty response) at the commencement of a command's execution.

### ON_START_RESPONSE Example

In some scenarios, upon triggering a command the response can take a particular amount of time before the response is sent back to the ECU. The ECU might want to know that the command has started the execution. When the ECU adds the on_start_response header 210A15, the interface will generate a temporal response with result code on start response to indicate the ECU that the command is currently running.

As an example, the ECU wants to read 1 kbyte of data from a sensor. The command will take 500 ms to complete, but the ECU want to know that the command started. The ECU adds this header to the command execution.
1. When the interface triggers the command, the interface generates a on start result response to the ECU.
2. 500 ms later, when all data is available, the data is sent to the ECU in a different response.

### METADATA Header 210A16

When the metadata header 210A16 is present in a command, the payload field will be included as is in the response.

A length field 210A16A specifies the length of the metadata payload in bytes. A value of the length field 210A16A equal to 0 indicates a length of 256 bytes.

A payload field 210A16B includes the actual metadata information. The length of the payload field 210A16B is specified by a metadata field 210A16C. The content depends on the ECU that generated the command, and can be any relevant data that needs to be sent along with the response.

### Metadata Header Example

In some scenarios, the ECU might want to include internal information to the response of the command execution, as the internal information can ease the processing of the response.

In an example, the ECU wants to add the serial number of a device that needs to receive the response of the node. The ECU needs to resend the serial number upon reception and does not want to keep an internal list.
1. The ECU adds the metadata header 210A16 to the command execution, including as the payload the serial number.
2. The ECU receives the response, decodes the metadata header to extract the serial number, and routes the response to the required device.

It is to be appreciated that the interface does nothing with the metadata. The metadata is just send back to the ECU.

### NO_RESPONSE Header 210A17

To maintain robustness in the communication process, all interfaces upon executing a command are required to generate a response, even if that response includes no data (i.e., an empty response). However, recognizing that in certain situations it may not necessitate the overhead of confirming an empty response, the protocol incorporates flexibility with the no_response header 210A17 in the command message can be utilized to indicate whether a response should be omitted.

In some cases, the ECU wants to execute a command without generating any upstream response. In this scenario, if the ECU adds the NO_RESPONSE header 210A17 to the command, the interface upon execution will discard the response without sending the response back to the ECU.

### CANCEL_COMMAND Commmand 210A18

The cancel_command command 210A18 is used to cancel a previously sent command message that is still stored in memory at the remote node.

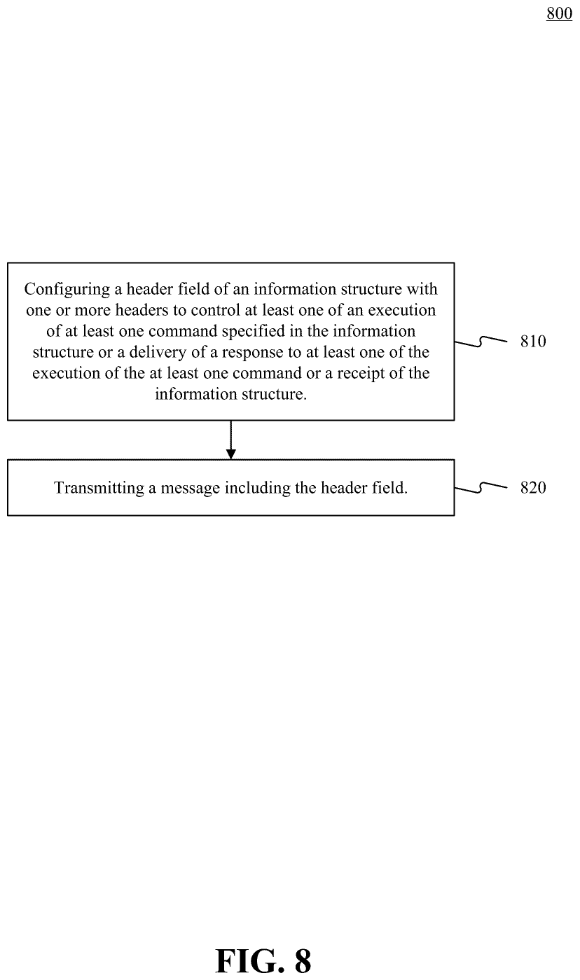

Referring to FIG. 8, an example communication method 600 is shown, in accordance with an example aspect.

At step 810, the method 800 includes configuring a header field 210A of an information structure 200 with one or more headers 210A1 through 210A18 to control at least one of an execution of at least one command specified in the information structure 200 or a delivery of a response to at least one of the execution of the at least one command or a receipt of the information structure 200.

At step 820, the method 800 includes transmitting a message including the header field 210A.

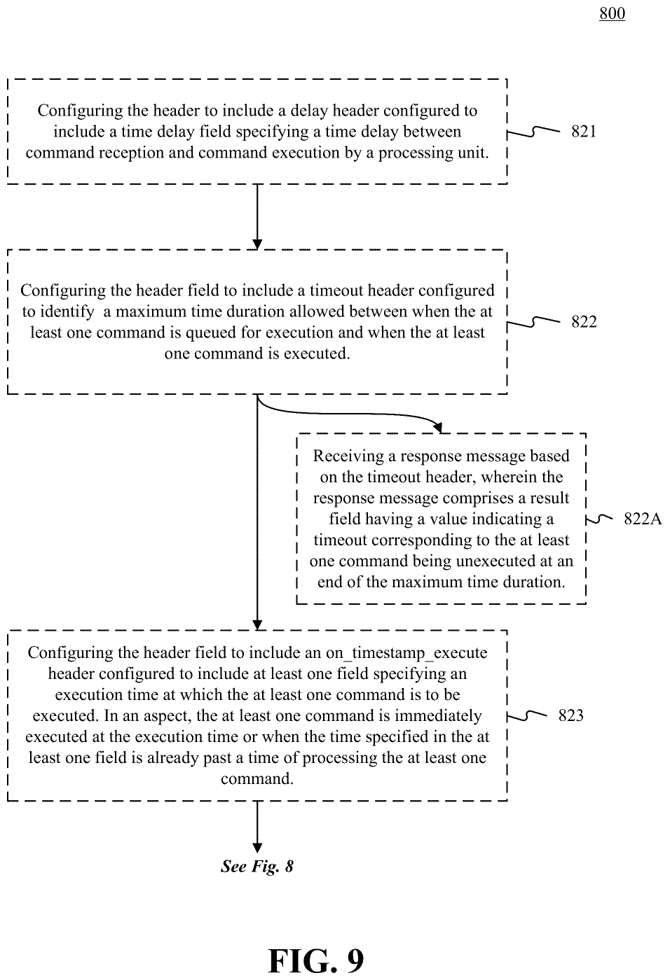

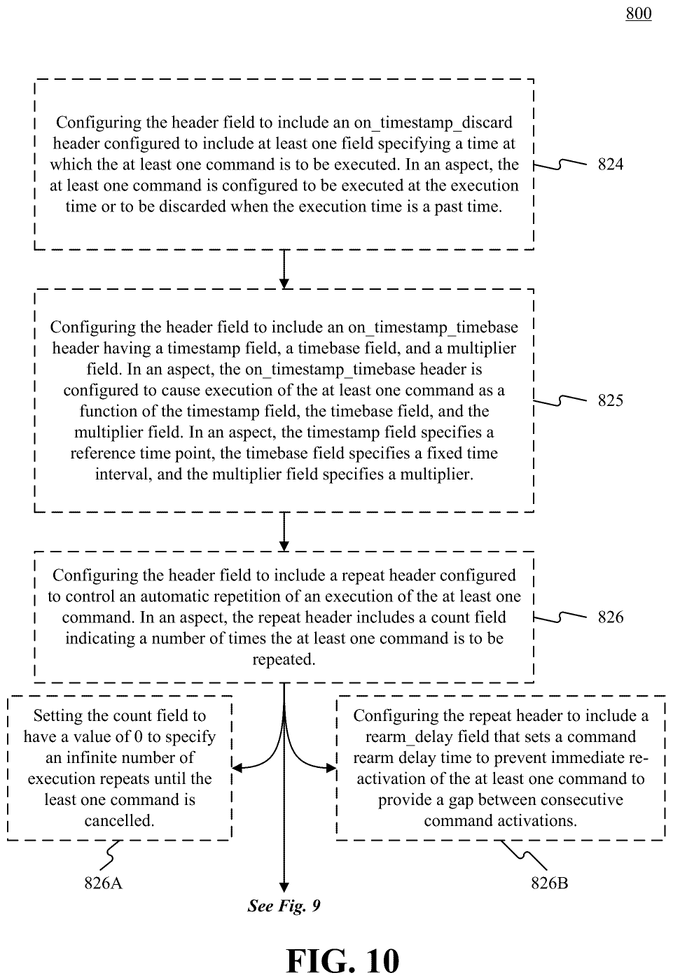

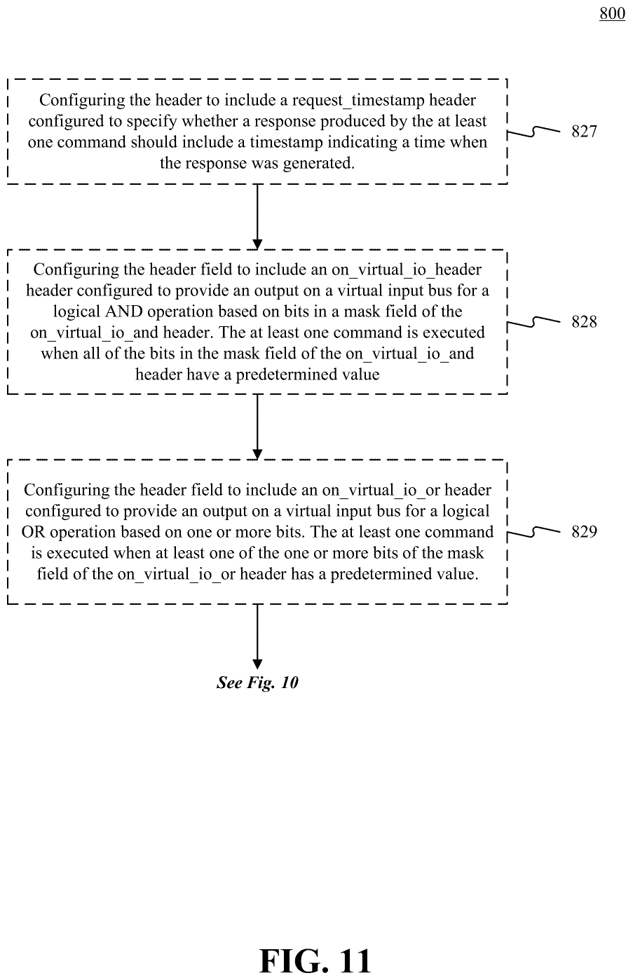

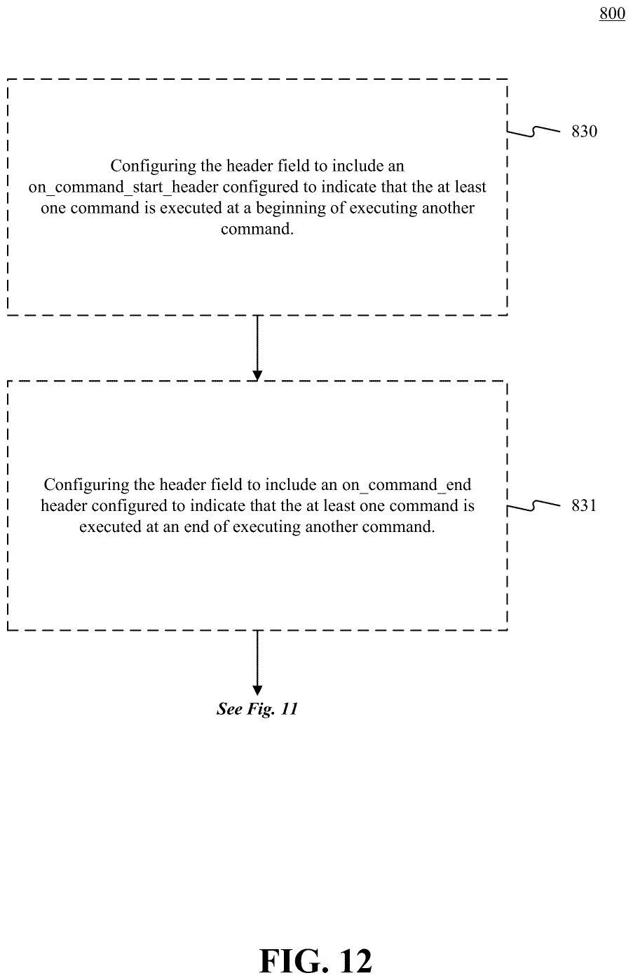

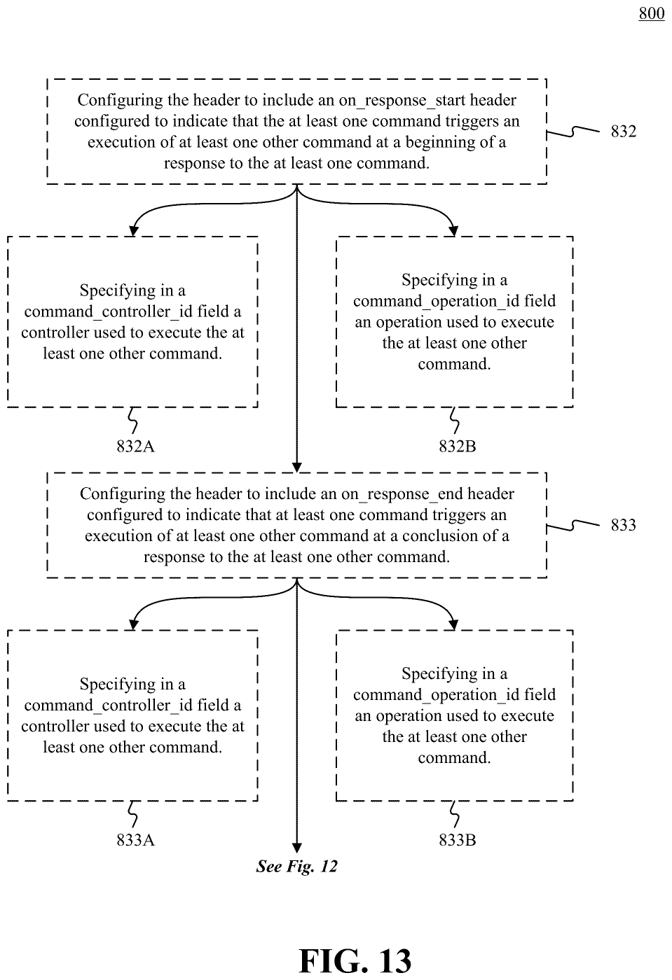

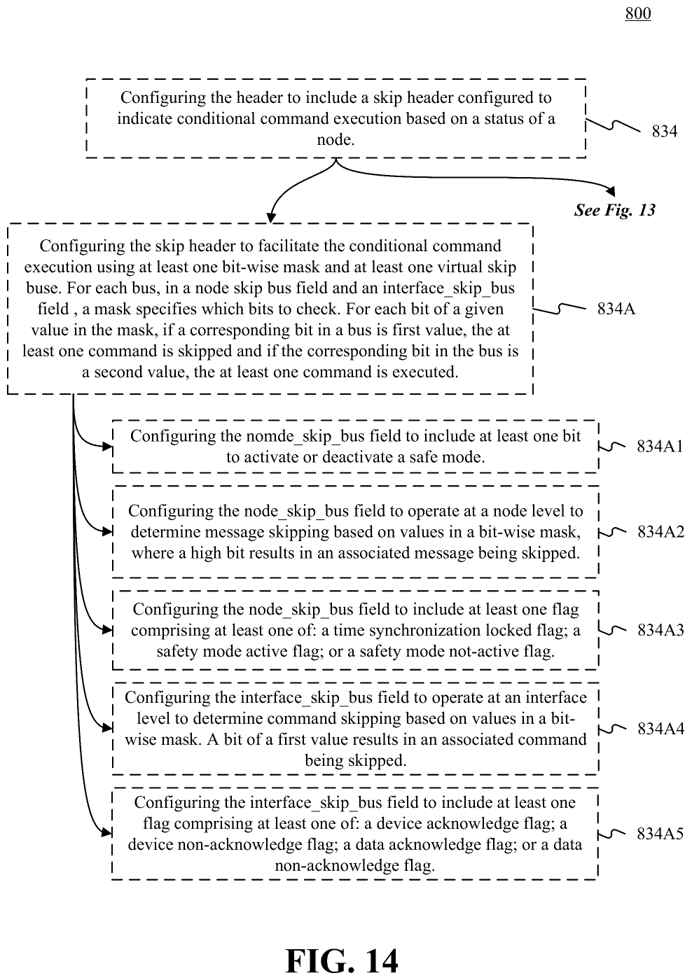

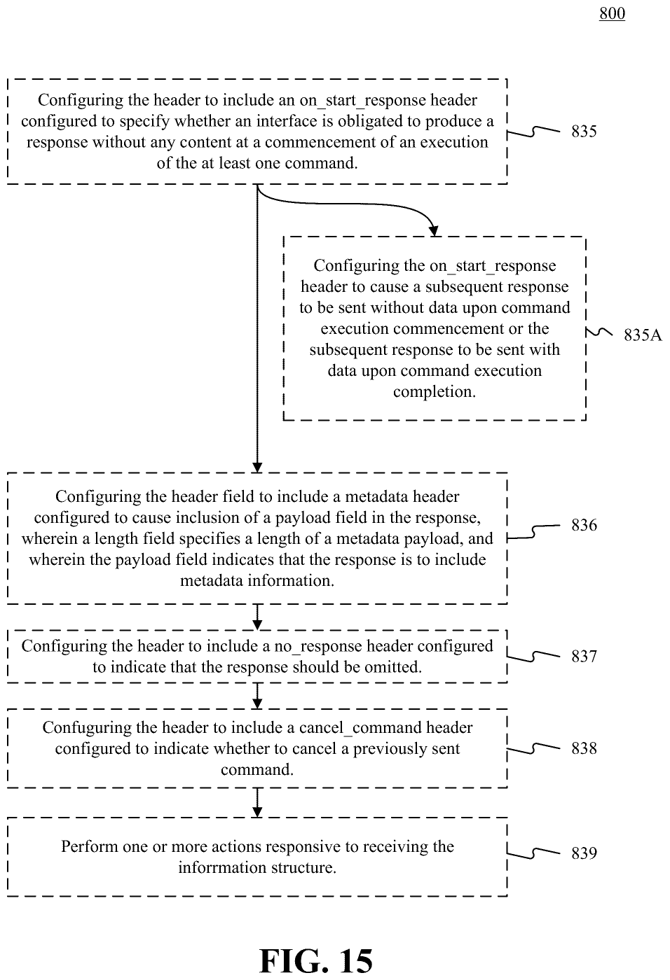

Referring to FIGS. 9-15, further blocks of the communication method 800 are shown, in accordance with an example aspect. These further blocks are all options that can be performed individually or in any combination.

At block 821, the method 800 includes configuring the header field 210A to include a delay header 210A1 configured to include a time delay field 210A1A specifying a time delay between command reception and command execution by a processing unit.

At block 822, the method 800 includes configuring the header field 210A to include a timeout header 210A2 configured to identify a maximum time duration allowed between when the at least one command is queued for execution and when the at least one command is executed.

In an aspect, block 822 can include block 822A.

At block 822A, the method 800 includes receiving a response message based on the timeout header 210A2, wherein the response message comprises a result field having a value indicating a timeout corresponding to the at least one command being unexecuted at an end of the maximum time duration.

At block 823, the method 800 includes configuring the header field 210A to include an on_timestamp_execute header 210A3 configured to specify a TIMESTAMP based execution time for the at least one command.

At block 824, the method 800 includes configuring the header field 210A to include an on_timestamp_discard header 210A4 configured to include at least one field 210A4A and/or 210A4B specifying a time at which the at least one command is to be executed. In an aspect, the at least one command is configured to be executed at the execution time or to be discarded when the execution time is a past time.

At block 825, the method 800 includes configuring the header field 210A to include an on_timestamp_timebase header 210A5 having a timestamp field 210A5A and/or 210A5B, a timebase field 210A5C, and a multiplier field 210A5D. In an aspect, the on_timestamp_timebase header 210A5 is configured to cause execution of the at least one command as a function of the timestamp field 210A5A and/or 210A5B, the timebase field 210A5C, and the multiplier field 210A5D. In an aspect, the timestamp field 210A5A and/or 210A5B specifies a reference time point, the timebase field 210A5C specifies a fixed time interval, and the multiplier field 210A5D specifies a multiplier.

At block 826, the method 800 includes configuring the header field 210A to include a repeat header 210A6 configured to control an automatic repetition of an execution of the at least one command. In an aspect, the repeat header 210A6 includes a count field 210A6A indicating a number of times the at least one command is to be repeated.

In an aspect, block 826 may include one or more of blocks 826A and 826B.

At block 826A, the method 800 includes setting the COUNT field 210A6A to have a value of 0 to specify an infinite number of execution repeats until the least one command is cancelled.

At block 826B, the method 800 includes configuring the REPEAT header 210A6 to include a rearm_delay field 210A6B that sets a command rearm delay time to define a delay, e.g., a time duration, to prevent immediate re-activation of the at least one command to provide a gap between consecutive command activations.

At block 827, the method 800 includes configuring the header field 210A to include a request_timestamp header 210A7 configured to specify whether a response produced by the at least one command should include a timestamp indicating a time when the response was generated.

At block 828, the method 800 includes configuring the header field 210A to include an on_virtual_io_and header 210A8 configured to provide an output on a virtual input bus for a logical AND operation based on bits in a mask field 210A8A of the on_virtual_io_and 110A8 header. The at least one command is executed when all of the bits in the mask field 210A8A of the on_virtual_io_and 110A8 header have a predetermined value.

At block 829, the method 800 includes forming the configuring the header field 210A to include an on_virtual_io_or header 110A9 configured to provide an output on a virtual input bus for a logical OR operation based on one or more bits in a mask field 110A9A of the on_virtual_io_or header 110A9. The at least one command is executed when at least one of the one or more bits in the mask field 110A9A of the on_virtual_io_or header 110A9 has a predetermined value.

At block 830, the method 800 includes configuring the header field 210A to include an on_command_start header configured to indicate that the at least one command is executed at a beginning of executing another command.

At block 831, the method 800 includes configuring the header field to include an on_command_end header configured to indicate that the at least one command is executed at an end of executing another command.

At block 832, the method 800 includes configuring the header field 210A to include an on_response_start header 210A12 configured to indicate that the at least one command triggers an execution of at least one other command at a beginning of a response to the at least one command.

In an aspect, block 832 includes one or more of blocks 832A and 832B.

At block 832A, the method 800 includes specifying in a command_controller_id field 210A12A an identifier of a controller used to execute the at least one other command.

At block 832B, the method 800 includes specifying in a command_operation_id field 210A12B an identifier of an operation used to execute the at least one other command.

At block 833, the method 800 includes configuring the header field 210A to include an on_response_end header 210A13 configured to indicate that at least one command triggers an execution of at least one other command at a conclusion of a response to the at least one other command.

In an aspect, block 833 may include one or more of blocks 833A and 833B.

At block 833A, the method 800 includes specifying in a command_controller_id field 210A13A a controller used to execute the at least one other command.

At block 833B, the method 800 includes specifying in a command_operation_id field 210A13B an operation used to execute the at least one other command.

At block 834, the method 800 includes configuring the header field 450 to include a skip header 210A14 configured to indicate conditional command execution based on a status of a node.

In an aspect, block 834 may include one or more of block 834A.

At block 834A, the method 800 includes configuring the SKIP header 210A14 to facilitate the conditional command execution using at least one bit-wise mask and at least one virtual skip buse. For each bus, in a node_skip_bus field 110A14A and an interface_skip_bus field 210A14B, a mask specifies which bits to check. For each bit of a given value in the mask, if a corresponding bit in a bus is first value, the at least one command is skipped and if the corresponding bit in the bus is a second value, the at least one command is executed.

In an aspect, block 834A may include one or more of blocks 834A1-834A5.

At block 834A1, the method 800 includes configuring the node_skip_bus field 210A14A to include at least one bit to activate or deactivate a safe mode.

At block 834A2, the method 800 includes configuring the node_skip_bus 210A14B field to operate at a node level to determine message skipping based on values in a bit-wise mask, where a high bit results in an associated message being skipped.

At block 834A3, the method 800 includes configuring the node_skip_bus field 210A14B to include at least one flag comprising at least one of: a time synchronization locked flag; a safety mode active flag; or a safety mode not-active flag.

At block 834A4, the method 800 includes configuring the interface_skip_bus field 210A14A to operate at an interface level to determine command skipping based on values in a bit-wise mask. A bit of a first value results in an associated command being skipped.

At block 834A5, the method 800 includes configuring the interface_skip_bus field 210A14A to include at least one flag comprising at least one of: a device acknowledge flag; a device non-acknowledge flag; a data acknowledge flag; or a data non-acknowledge flag.

At block 835, the method 800 includes configuring the header field 450 to include an on_start_response header 210A15 configured to specify whether an interface is obligated to produce a response without any content at a commencement of an execution of the at least one command.

In an aspect, block 835 may include block 835A.

At block 835A, the method 800 includes configuring the on_start_response header 210A15 to cause a subsequent response to be sent without data upon command execution commencement or the subsequent response to be sent with data upon command execution completion.

At block 836, the method 800 includes configuring the header field 450 to include a metadata header 210A16 configured to cause inclusion of a payload field 210A16B in the response, wherein a length field 210A16A specifies a length of a metadata payload, and wherein the payload field 210A6B indicates that the response is to include metadata information.

At block 837, the method 800 includes configuring the header field 450 to include a no_response header 210A17 configured to indicate that the response should be omitted.

At block 838, the method 800 includes configuring the header field 450 to include a cancel_command header 210A18 configured to indicate whether to cancel a previously sent command.

At block 839, the method 800 includes performing an action responsive to receiving the message, The step can be performed by a receiving node or an intermediate node such as an ECU that the receives, e.g., sensor data, decides a course of action and then transmits the course of action as instructions to another node that can react such as a breaking unit in a vehicle, a steering unit in a vehicle, a lighting unit in a vehicle, a robot or robotic portion such as an arm, and so forth. These are merely exemplary actions that may be performed depending upon the implementation.

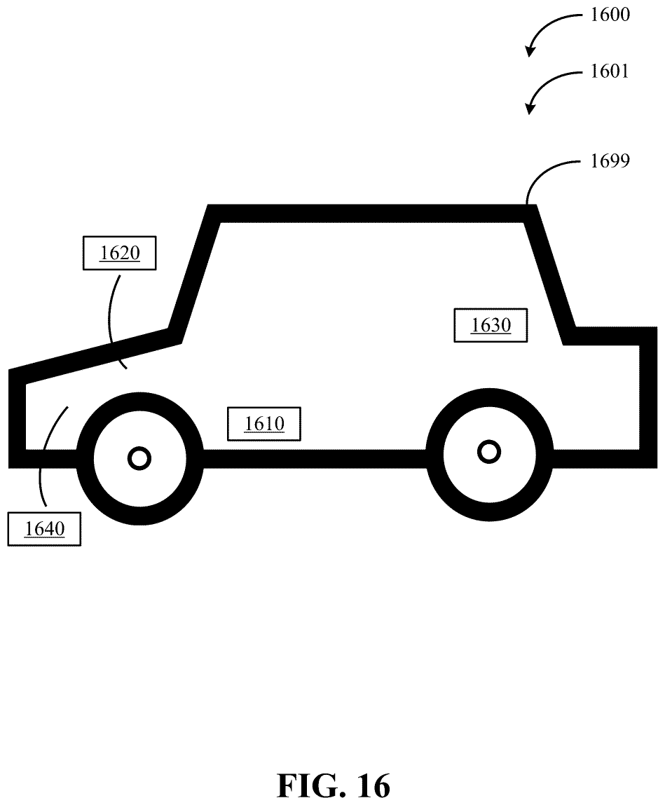

Referring to FIG. 16, an example communication system 1600 having an Electronic Controller Unit (ECU) 1610 and a set of remote nodes 1601 is shown, in accordance with an example aspect. The set of remote nodes 1601 includes nodes 1620, 1630, and 1640, corresponding to wireless nodes 110 of FIG. 1.

The ECU 1610 and the set of remote nodes 1601 communicate using messages that include, e.g., information structure 200 of FIG. 2 which, in turn, may include headers 210A and header fields and sub-fields as shown in FIGS. 2-6. In an aspect, each of the headers 210A is configured control at least one of an execution of at least one command specified in an information structure 200 or a delivery of a response to at least one of the execution of the at least one command or a receipt of the information structure 200. In an aspect, communication system 1600 can be a 10BASE-T1S communication system of Analog Devices® of Massachusetts, USA.

In the example of FIG. 16, the communication system 1600 can be installed in, and correspond to, a vehicle 1699. For example, the ECU 1610 may be the main controller of the vehicle 1699 and the set of remote nodes 1601 may correspond to vehicle systems such as steering, accelerating, braking, stability, audio (telephone, music, etc.), lighting, and so forth. However, it is to be appreciated that aspects of the present disclosure are not limited to a vehicle and can be applied to any type of system that includes an ECU and remote nodes such as a robotic system, a surveillance system, a facility access system, and so forth. For example, in the case of a robotic system, the remote nodes 1601 can represent motors for controlling movement and arms of robots.

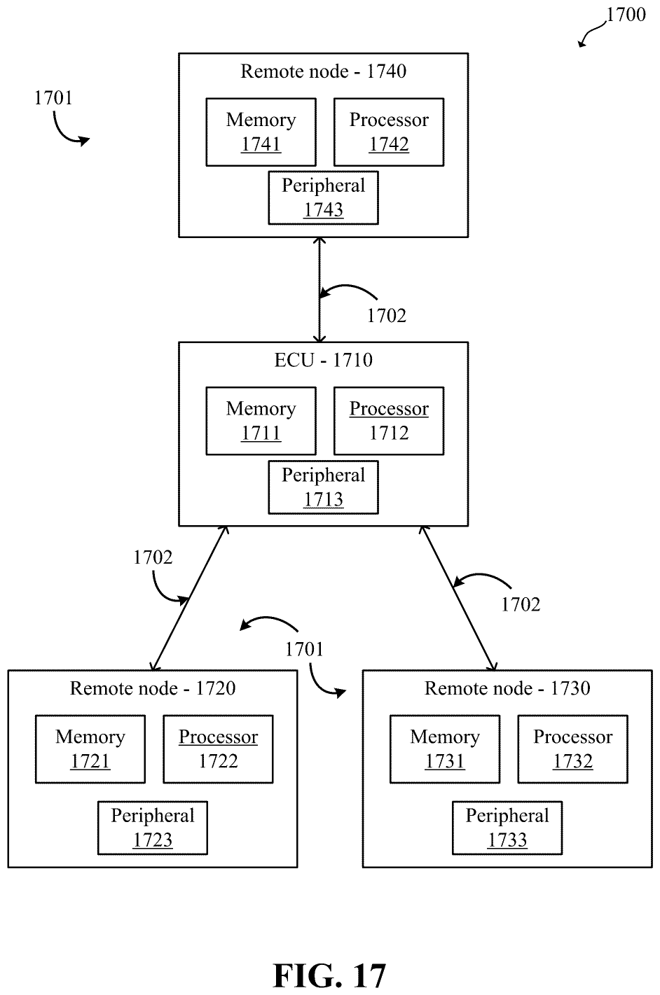

Referring to FIG. 17, examples of the ECU 1710 and set of nodes 1601 are shown, in accordance with an example aspect. While FIG. 1 includes nodes 110 and an ECU 199 which communicate wirelessly, FIG. 17 includes nodes 1701 and an ECU 1710 which communicate using wires 1702. Other implementations may form a hybrid wired and wireless system. Communication system 1600 in vehicle 1699 of FIG. 16 may implement a wireless system (e.g., see FIG. 1), a wired system (e.g., see FIG. 17), and/or a hybrid communication system including aspects of both a wireless and a wired communication system. As one example, vehicle 1699 may include a wired communication system such as communication system 1700 shown in FIG. 17, but ECU 1710 may further include a transceiver as a peripheral device 1713 to upload (transmit) and download (receive) data corresponding to and/or otherwise including and/or involving firmware updates, driving pattern recognition data, driving characteristics recognition data, and so forth.

Each of the ECU 1710 and/or the nodes 1701 may include one or more memories 1X1 (i.e., ECU 1710 includes one or memories 1711, remote node 1720 includes one or more memories 1721, remote node 1730 includes one or more memories 1731, remote node 1740 includes one or more memories 1741, and so forth), individually or in combination, having instructions. Each of the ECU 1710 and/or the nodes 1701 may include one or more processors 14Y2 (i.e., ECU 1710 includes one or more processors 1712, remote node 1720 includes one or more processors 1722, remote node 1730 includes one or more processors 1732, remote node 1740 includes one or more processors 1742, and so forth) each coupled to at least one of the one or more memories 14X1 and configurable to execute the instructions. In various aspects, ECU 1710 is superior to in hierarchy, and provides instructions, for the one or more processors 1712, 1722, and 1732. In various aspects, only ECU 1710 includes the one or more memories and one or more processors, and provides signals for controlling the remote nodes 1720, 1730, and 1740.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

In various aspects, ECU 1710 and/or remote nodes 1701 may include one or more peripherical devices 17X3 (i.e., ECU 1710 includes peripheral device(s) 1713, remote node 1720 includes peripheral device(s) 1723, remote node 1730 includes peripheral device(s) 1733, remote node 1740 includes peripheral device(s) 1743, and so forth). For example, the ECU 1710 may include one or more input devices as peripheral device(s) 1713. As a further example, the remote nodes 1701 may include one or more motors, lights, speakers, displays, and so forth as peripheral device(s) 1723, 1733, and/or 1743.

ECU 1710 and remote nodes 1720, 1730, and 1740 are connected by one or more wires 1702. For example, but not limited hereto, any of the following cable types may be used: coaxial; twisted pair; and fiber-optic cabling. In current LANs, the twisted pair cabling is the most popular type of cabling, but the fiber-optic cabling usage is increasing, especially in high performance networks.

The remote nodes 1720, 1730, and 1740 send back responses to the ECU 1710, attaching the sequence number and the topic that came with the original command, and an interface identification number. This way, the ECU 1710 can map a response to its related command.

Aspects of the present disclosure improve E2B technology ensuring that commands from an electronic control unit (ECU) in automotive, industrial, or other environment can be sequenced in remote nodes even if they are part of different interfaces while they can also react to different event or trigger conditions, as defined by the ECU.

In an RCP protocol, the controller needs to wait for the current executed RCP command to be completed before executing the next command. In the E2B technology, we let the ECU to queue and schedule consecutive commands, that are then executed based on different trigger configurations, like the execution of another command, in a different node, time, or to react to external signals. I believe the ability of queuing, scheduling commands between interfaces and, time synchronization and reaction to external signals and conditional execution due to previous errors is key to the E2B protocol.

### 0x05 NACK_STREAM Message Description

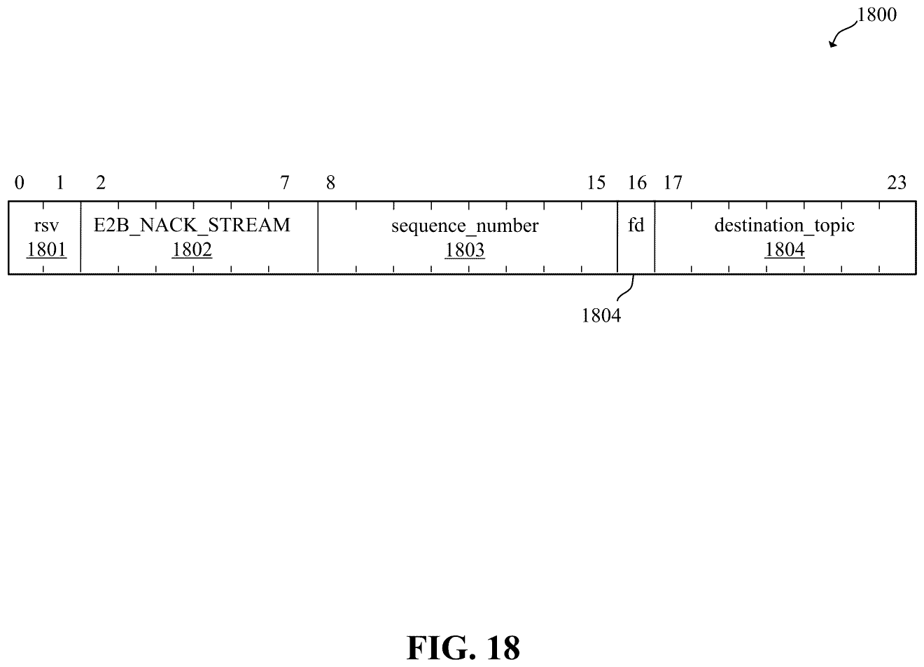

Referring to FIG. 18, an example NACK_STREAM command payload 1800 is shown, in accordance with an exemplary aspect.

fd 1804: Indicates if the LCE discarded an incoming message. fd 1804 must be set when it detected an older messages and cleared when there was a missing message.

sequence_number 1803: Indicates the next expected number by the received.

destination_topic 1804: Indicates the topic that generated the nack message.

E2B_NACK_STREAM 1802 is generally used by the receiver to indicate whether an error occurred somewhere in the data transmission. Rsv 1801 includes reserved bits.

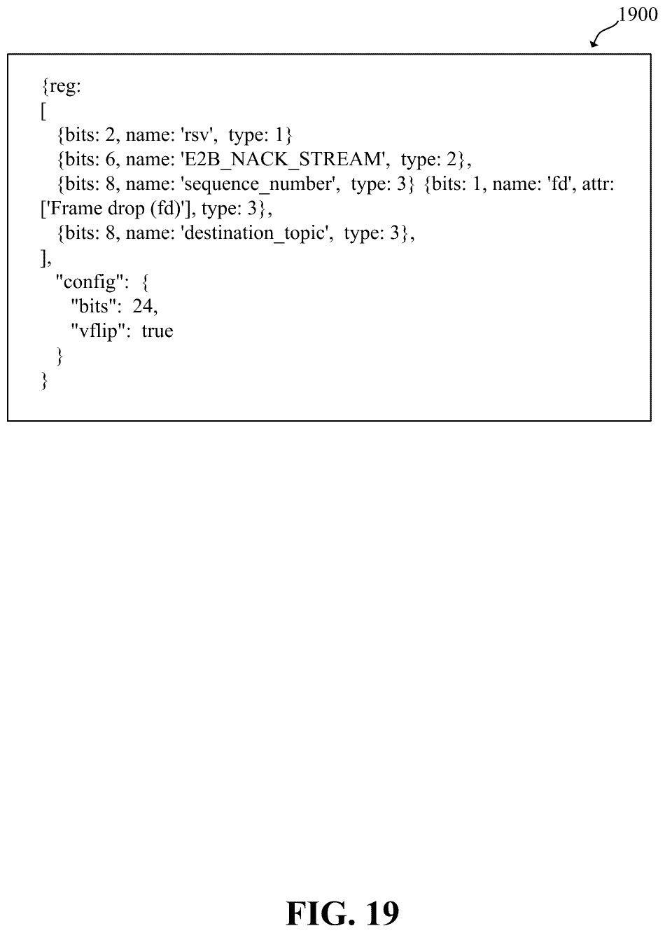

Referring to FIG. 19, an example E2B_NACK_STREAM message 1900 is shown, in accordance with an exemplary aspect.

In Cutlass, this message 1900 does not follow the LUT based messaging system.

### 0x6 ACK_MAILBOX Message Description

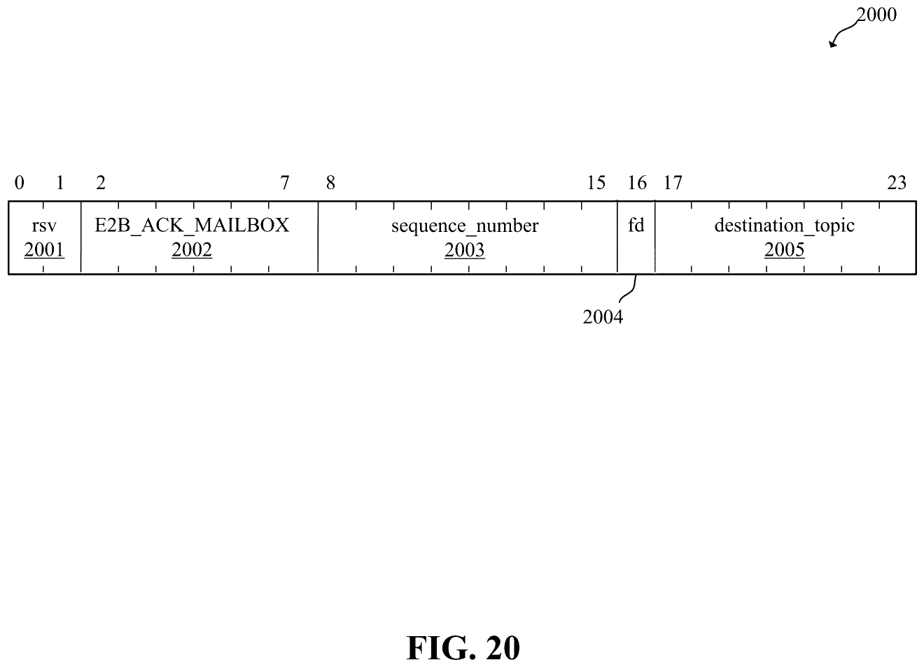

Referring to FIG. 20, an example ACK_MAILBOX command payload 2000 is shown, in accordance with an exemplary aspect.

fd 2004: Indicates if the LCE discarded an incoming message. fd 2004 must be set when the detected sequence number in the incoming command did not match the expected sequence number.

sequence_number 2003: Indicates the next expected number by the received.

destination_topic 2005: Indicates the topic that generated the ack message.

E2B_ACK_MAILBOX 2002 indicates received acknowledgments. Rsv 2001 includes reserved bits.

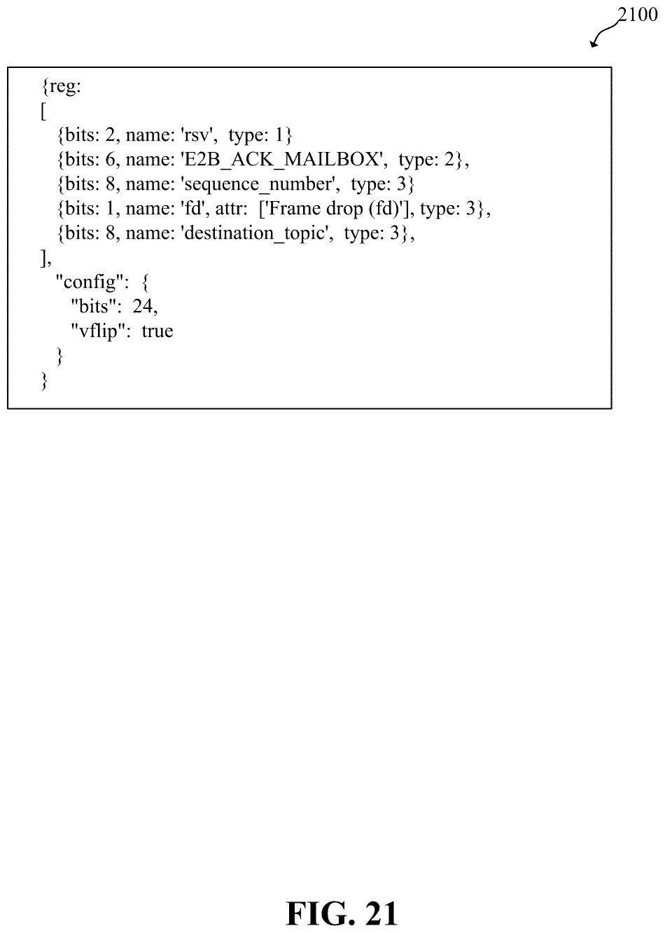

Referring to FIG. 21, an example E2B_ACK_MAILBOX message 2100 is shown, in accordance with an exemplary aspect.

In Cutlass, this message 2100 does not follow the LUT based messaging system.

### 0x07 COMMAND and 0x08 RESPONSE

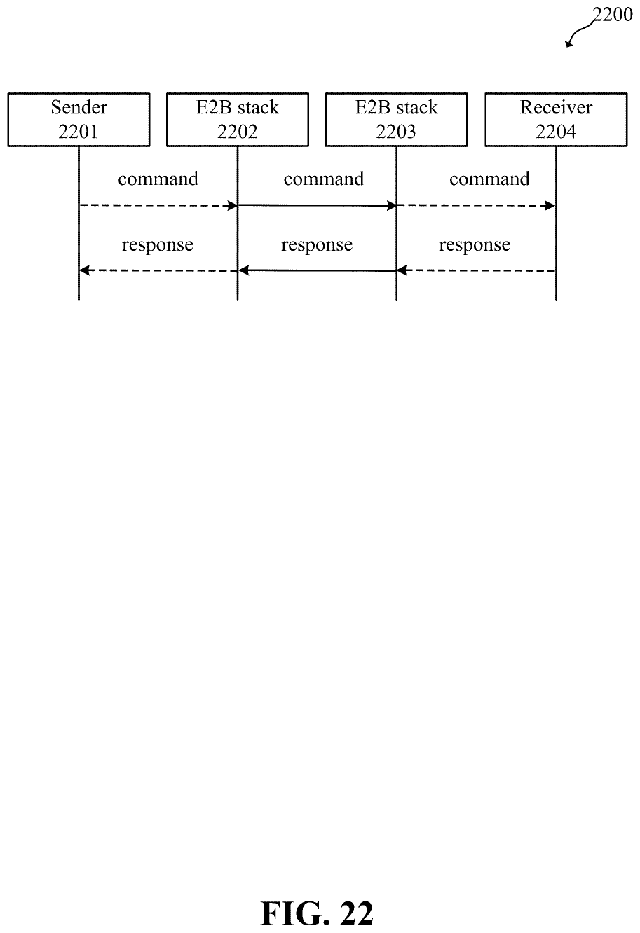

Referring to FIG. 22, an example command and response data flow 2200 is shown, in accordance with an exemplary aspect.

The receiver 2204 sends back the response to the sender 2201 via the E2B stack 2202 and E2B stack 2203, attaching the sequence number and the topic that came with the original command and an interface identification number. This way, the ECU can map a response to its related command.

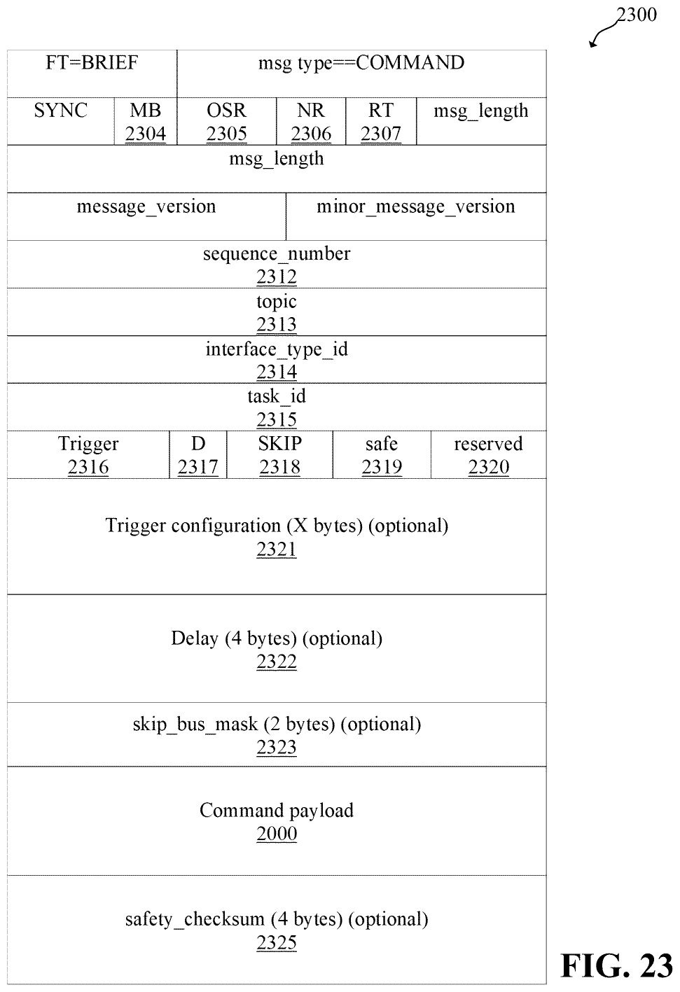

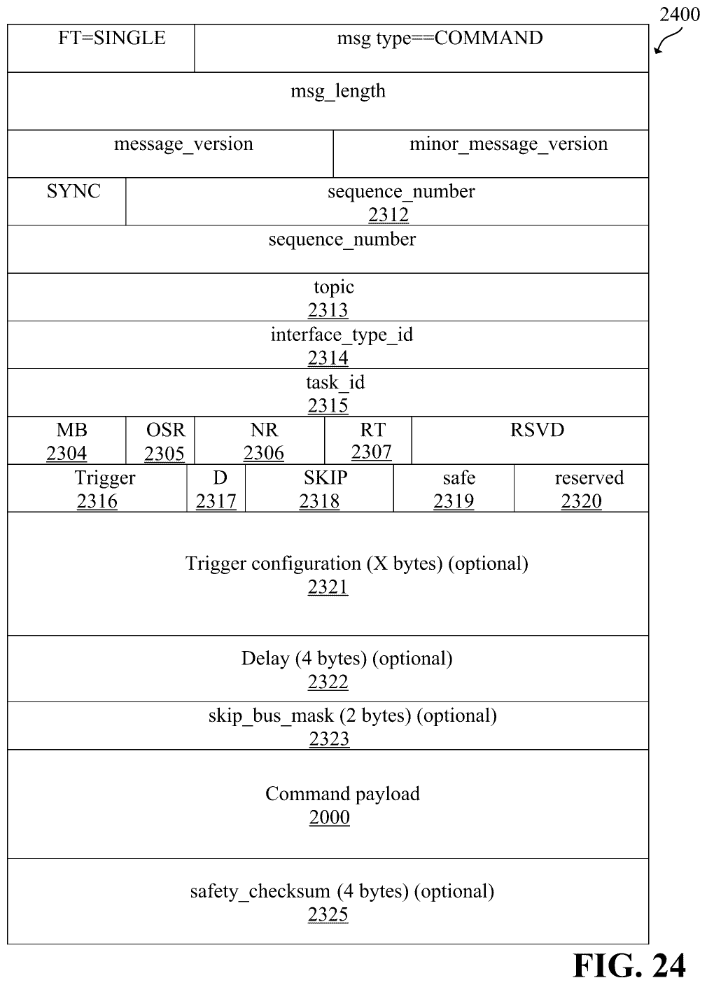

Referring to FIGS. 23 and 24, an example brief 0x05 COMMAND message 2300 and single 0x05 COMMAND message 2400 are respectively shown, in accordance with exemplary aspects.

These message types together helps E2B to implement a command/response architecture.

There are two components that form part of E2B communication:

Sender/ECU 2201: The entity that sends the command.

Receiver/Remote node 2204: The entity that processes the command and sends back the response.

### 0x07 Command Message Description

In the command message 2300, the tracking of sequence number is linked to their respective topics, forming a unique combination of “sequence_number per topic.” This means that each command is not just assigned a sequential number but is also categorized based on its specific topic.

mailbox (MB): The MB field 2304 determines the safety level of the command being transmitted. The MB field 2304 enables the selection between “critical” and “non-critical” data categories: Non-critical data (0): Indicates that the data is of low importance and messages can be skipped.

critical data (1): Indicates that the data is of high importance and messages cannot be lost or skipped.

on_start_response (OSR): An interface may also need some time to fully execute a command prior to generating a response. As an optional feature, the on_start_response field 2305 specifies whether the interface is obligated to produce a response without any content (essentially, an empty response) at the commencement of a command's execution.

no_response (NR): To maintain robustness in the communication process, all interfaces upon executing a command are required to generate a response, even if that response contains no data (i.e., an empty response). However, recognizing that in certain situations it may not necessitate the overhead of confirming an empty response, the protocol incorporates flexibility with the no_response field 2306 in the command message can be utilized to indicate whether a response should be omitted.

response_timestamp (RT): The response_timestamp 2307 parameter specifies whether the response produced by the command should include a timestamp. The timestamp reflects the time when the response was generated.

topic: The topic field 2313 is designated for selecting the target interface to which the message is directed.

interface_type_id: The interface_type_id field 2314 is designated for selecting the formatting of the interface to which the message is directed. Each value of the interface_type_id field 2314 correlates to a distinct interface type, such as Serial Peripheral Interface (SPI), Inter-Integrated Circuit (I2C), Universal Asynchronous Receiver/Transmitter (UART), etc.

task_id: The task_id field 2315 identifies the specific task that the command is intended to trigger. The task_id indicated in the task_id field 2315 acts as a unique identifier, linking the message to a predefined task or operation within the interface. The value assigned to task_id field 2315 corresponds to a particular action or set of actions that the system recognizes and is programmed to execute upon receiving the message.

trigger: The trigger field 2316 selects the trigger for the current command.

trigger_configuration: The trigger_configuration field 2321 is designed to initiate a range of actions or commands upon receipt. The trigger field can include specifications such as execution time, virtual IO, or other specific commands. Depending on the value set within the trigger field, the receiving interface processing unit will perform different actions. For example, setting an execution time will schedule the action at the specified time, while specifying a virtual 10 trigger might wait until that condition is meet.

skip: The skip flag 2318 indicates of the presence of the associated skip_bus_mask field 2323 in the message. When set to true, the skip flag 2318 signifies that the mask is present and valid and accurately represents the configuration of the command execution skip functionality. Conversely, setting the skip flag 2318 to false implies that the skip_bus_mask field 2323 is not present in the response.

safe: The safe flag 2319 indicates of the presence of the associated safety_checksum field 2325 in the message. When set to 1, the safe flag 2319 signifies that its associated response will include the safety_checksum field 2325. This checksum serves as an additional layer of protection, verifying that the content of each message remains unaltered. This verification should be one of the last steps right before executing the command. The reserved field 2320 includes reserved bits.

skip_bus_mask: The skip_bus_mask 2323 is a two subfield mask that determines message skipping based on a bit-wise mask, where a high bit results in the associated message being skipped.

D: The D flag 2317 controls whether the delay field is included in the message. When set to true, the D flag 2317 indicates that the message includes the delay field 2322, specifying the nanosecond delay between message reception by the processing unit and execution. Conversely, setting the D flag 2317 to false omits the delay field 2322 from the message, implying immediate processing upon receipt by the processing unit.

delay: The delay field 2322 specifies the delay in nanoseconds between the reception of a message at the processing unit and its subsequent execution. The value entered in the delay field 2322 represents the exact duration that the system should wait before processing the received message.

safety_checksum: The safety_checksum field 2325 is calculated from the topic field and continues through to the last byte of the payload field. The generation of the calculation is standard for all the message main headers. In this case, brief headers are still calculated using the single message header format. The calculation of the safety_checksum field 2325 is identical to the CRC utilized in an Ethernet Frame Check Sequence (FCS) field and described in IEEE 802.3-2018 clause 3.2.9.

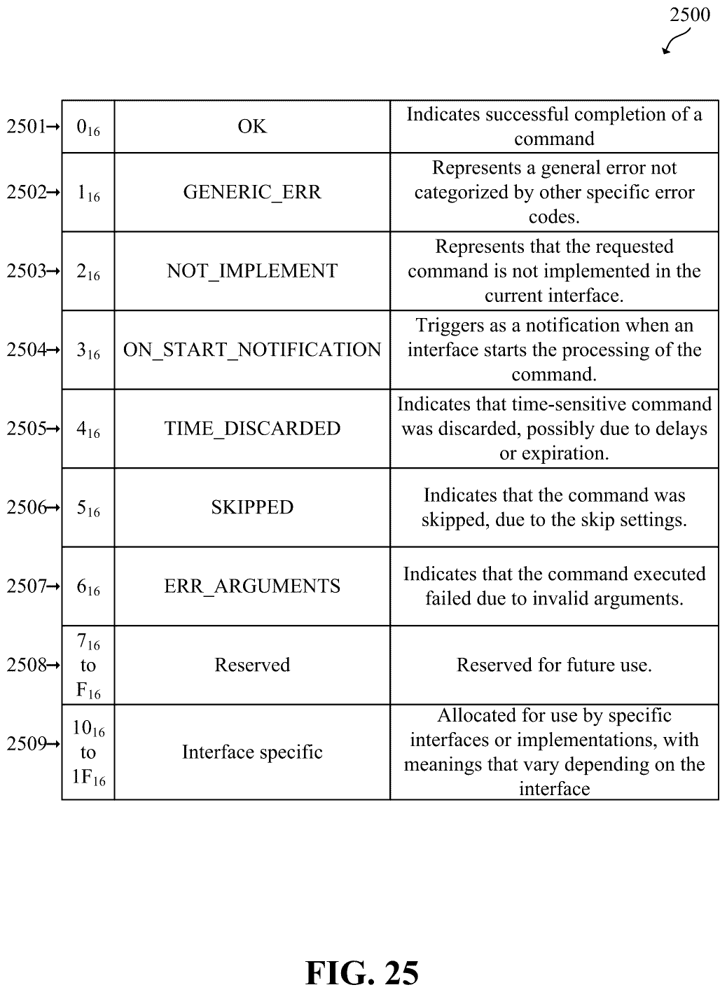

Referring to FIG. 25, exemplary RESULT (or RSLT) field values 2500 are shown, in accordance with an exemplary aspect.

The values include values 2501 through 2509 corresponding to the following fields: OK 2501; GENERIC_ERR 2502; NOT_IMPLEMENT 2503; ON_START NOTIFICATION 2504; TIME_DISCARDED 2505; SKIPPED 2506; ERROR_ARGUMENTS 2507; reserved 2508; and interface specific 2509. Capital letters indicate the name of a particular field. Field 2508 is unknown and field 2509 varies with interface type.

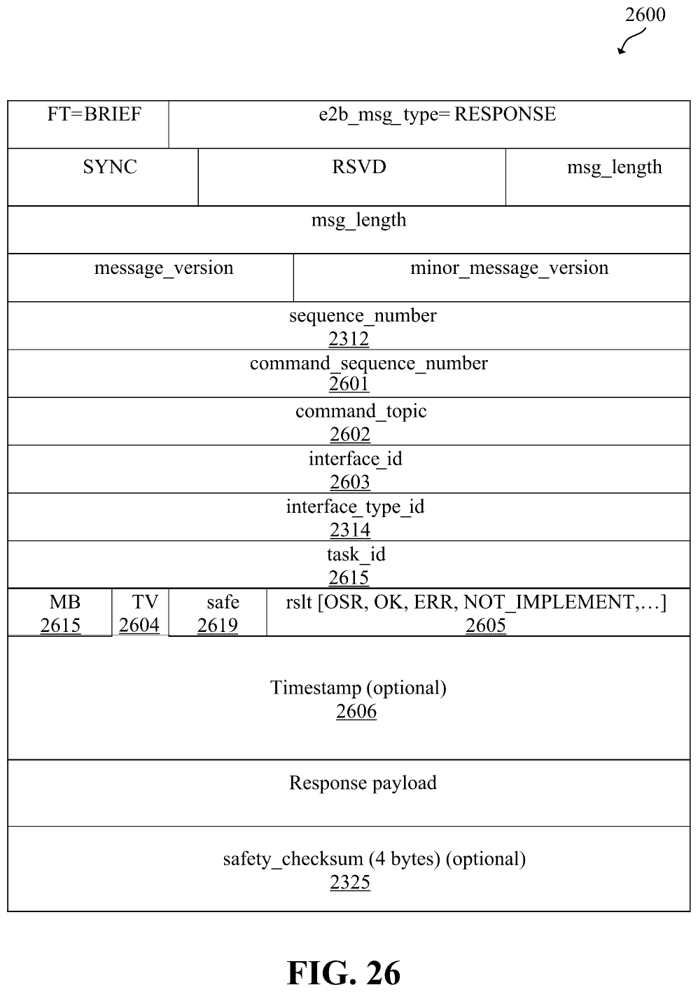

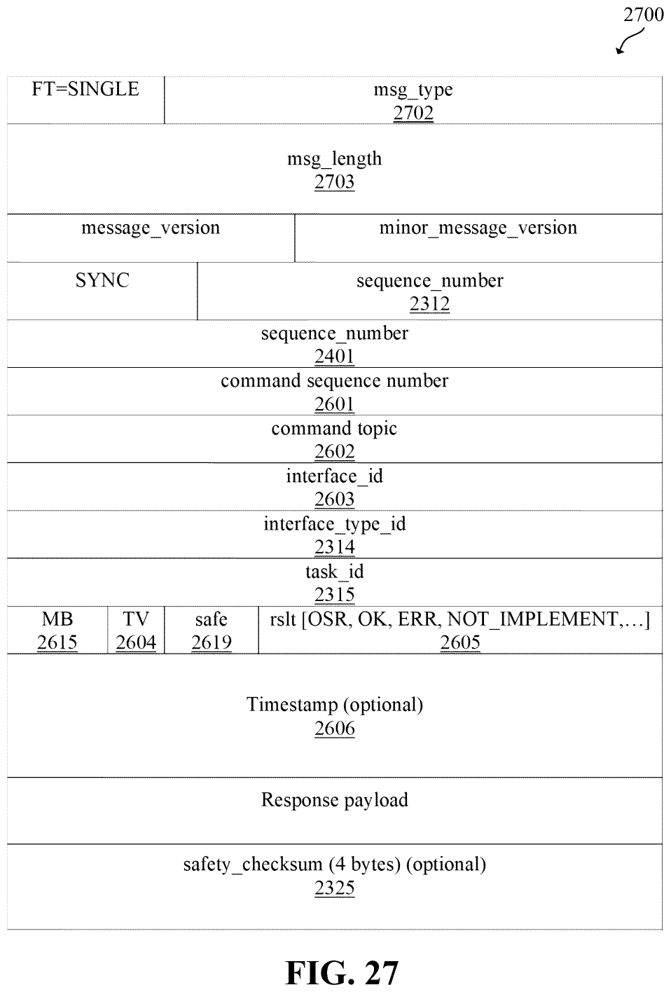

Referring to FIGS. 26 and 27, an example brief 0x06 RESPONSE message 2600 and single 0x06 RESPONSE message 2700 are respectively shown, in accordance with exemplary aspects.

### Response Message Description

In a response message, the tracking of sequence number is linked to their respective topic and interface_id, forming a unique combination of “sequence_number per topic and interface_id”. This means that each command is not just assigned a sequential number but is also categorized based on its specific topic and interface_id.

command_sequence_number: The command_sequence_number field 2601 is designed to reflect the same value as the sequence_number 2312 present in the command message 2300, that triggered the response. The command_sequence_number field 2601 serves as a continuity and verification mechanism, ensuring that the response is correlated with the correct sequence_number 2312 as specified in the original command.

command_topic: The command_topic field 2602 is designed to reflect the same value as the topic 2313 present in the command message 2300 that triggered the response. The command_topic field 2602 serves as a continuity and verification mechanism, ensuring that the response is correlated with the correct topic 2313 as specified in the original command 2300.

interface_id: The interface_id field 2603 uniquely identifies the specific interface on a remote node that has generated the response. In environments where a single node may have multiple interfaces capable of responding, the interface_id provides a unique identifier for each of these interfaces. The value assigned to the interface_id field 2603 is typically a unique identifier that distinguishes each interface on the node, allowing for clear and unambiguous identification, as is decided by the user administrator.

interface_type_id: The interface_type_id field 2314 is designed to reflect the same value as the interface_type_id 2314 present in the command message 2300 that triggered the response. The interface_type_id field 2314 serves as a continuity and verification mechanism, ensuring that the response is correlated with the correct interface type as specified in the original command.

task_id: The task_id field 2615 is designed to reflect the same value as the task_id 2315 present in the command message 2300 that triggered the response. The task_id field 2615 serves as a continuity and verification mechanism, ensuring that the response is correlated with the correct task id as specified in the original command.

MB: The MB field 2615 is designed to reflect the same value as the MB present 2304 in the command message 2300 that triggered the response. The MB field 2615 serves as a continuity and verification mechanism, ensuring that the response is correlated with the mailbox type as specified in the original command.

TV: The TV flag 2604 serves as an indicator of the presence of the associated timestamp field in the message. When set to true, the TV flag 2604 signifies that the timestamp is present and valid and accurately represents the time of the command execution. Conversely, setting the TV flag 2604 to false implies that the timestamp is not present in the response, as the command's field response_timestamp was set to false during the command execution that generated this response.

timestamp: The timestamp field 2606 indicates the specific point in time until which the associated payload data was acquired. In an aspect, the timestamp field 2606 includes two 32-bit variables: The first four bytes representing seconds and the last four bytes representing nanoseconds. Other units of types of numbers of bytes may be used, depending upon the implementation. The timestamp field 2606 is an optional field that is only present if the TV flag 2604 is set true.

safe: The safe flag 2619 indicates of the presence of the associated safety_checksum field 2325 in the message. When set to 1, the safe flag 2619 signifies that its associated response will include the safety_checksum field 2325. This checksum serves as an additional layer of protection, verifying that the content of each message remains unaltered. This verification should be one of the last steps right before executing the command.

rslt: The rslt field 2605 in the response message is used to convey the result of the command that was processed. The rslt field 2605 includes information regarding the success, failure, or status of the operation that was initiated by the preceding command. The rslt field 2605 can include various types of data such as status codes, error messages, or specific results of a computation or query.

### Trigger Configuration

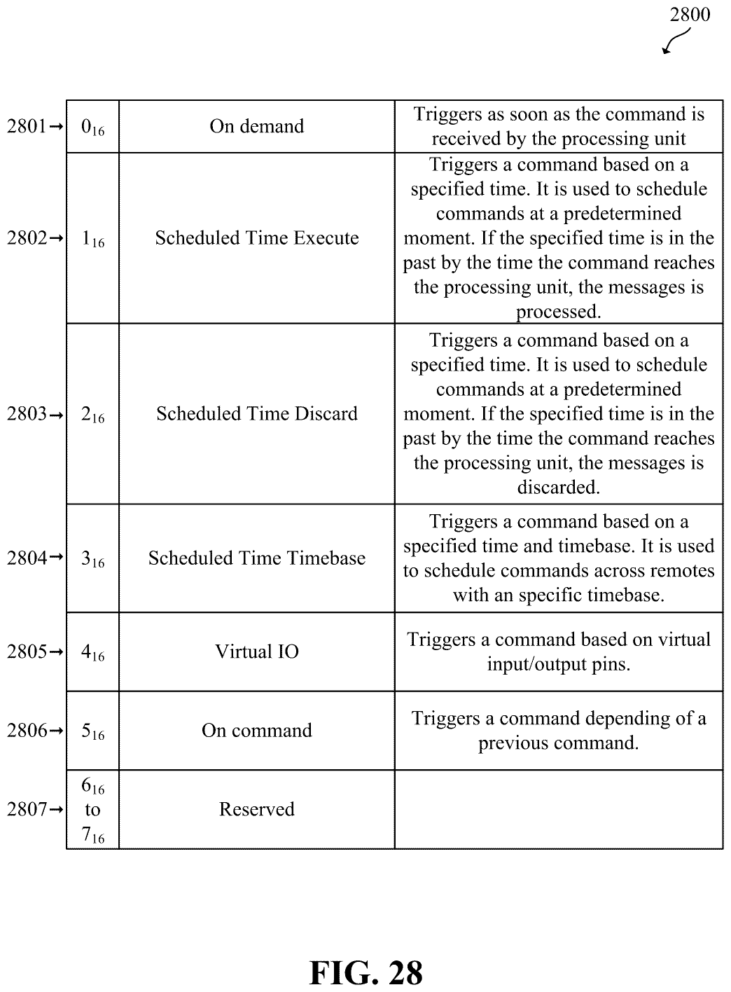

Referring to FIG. 28, exemplary trigger configuration values 2800 are shown, in accordance with an exemplary aspect.

The values include values 2801 through 2807 corresponding to the following fields: on demand 2801; scheduled time execute 2802; scheduled time discard 2803; scheduled time timebase 2804; virtual IO 2805; on command 2806; and reserved 2807.

### Trigger Configuration—On Demand

The “On Demand” trigger is designed to execute commands immediately upon becoming available. No extra configuration data is required.

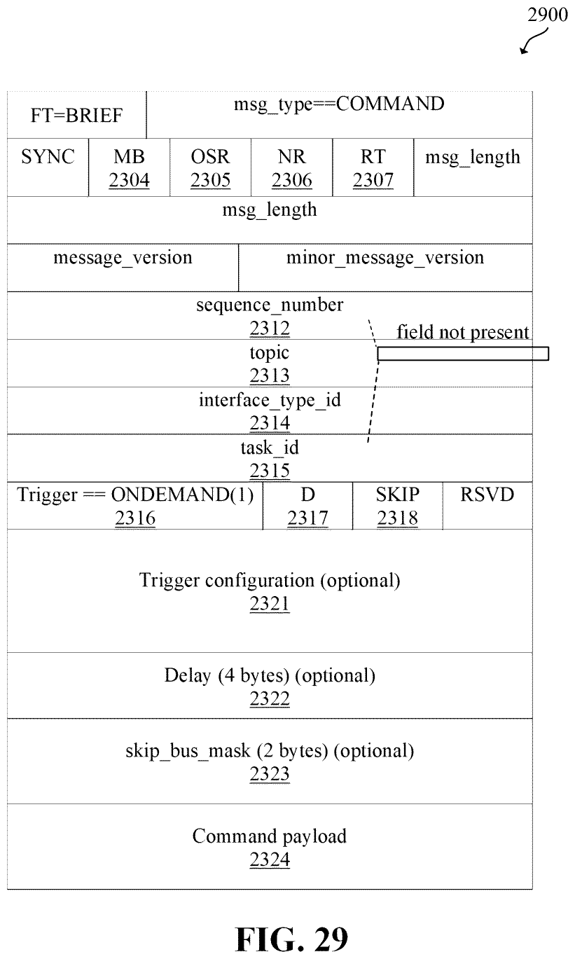

Referring to FIG. 29, exemplary trigger command settings 2900 on demand are shown, in accordance with an exemplary aspect.

### Trigger Configuration—On Timestamp Execute 110A3

This functionality is designed to execute commands based on a specific future timestamp, ensuring that actions are carried out at designated times. It operates by monitoring the current time against a timestamp in the timestamp field. When the system clock aligns with this timestamp, the command is executed.

In cases where the specified timestamp is already in the past at the time of processing, instead of discarding the command, the system executes it immediately.

TIMESTAMP: The TIMESTAMP field 2606 indicates the specific point in time until which the command needs to be executed. The TIMESTAMP field includes two 32-bit variables: The first four bytes representing seconds and the last four bytes representing nanoseconds.

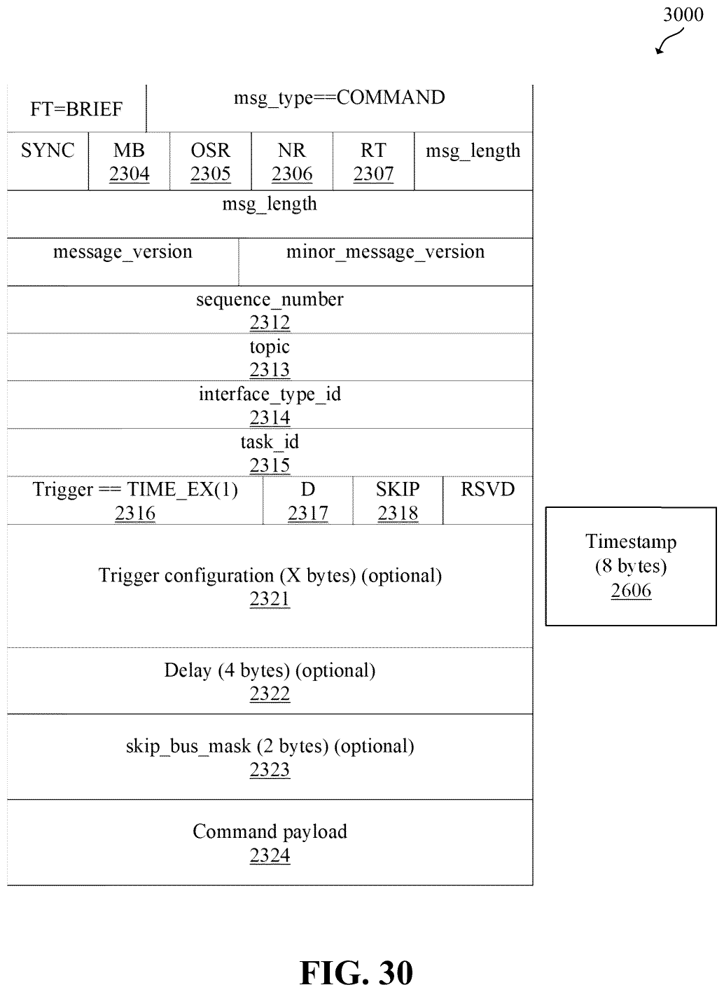

Referring to FIG. 30, exemplary trigger command settings 3000 on time stamp execute are shown, in accordance with an exemplary aspect.

### Trigger Configuration—On Timestamp Discard 110A4

This functionality is designed to execute commands based on a specific future timestamp, ensuring that actions are carried out at designated times. It operates by monitoring the current time against a timestamp in the timestamp field. When the system clock aligns with this timestamp, the command is executed.

However, if the timestamp for a command is already in the past at the time of the processing, the command is automatically discarded. This ensures that the system does not execute outdated or irrelevant commands.

timestamp: The timestamp field 2606 indicates the specific point in time until which the command needs to be executed. The timestamp field includes two 32-bit variables: The first four bytes representing seconds and the last four bytes representing nanoseconds.

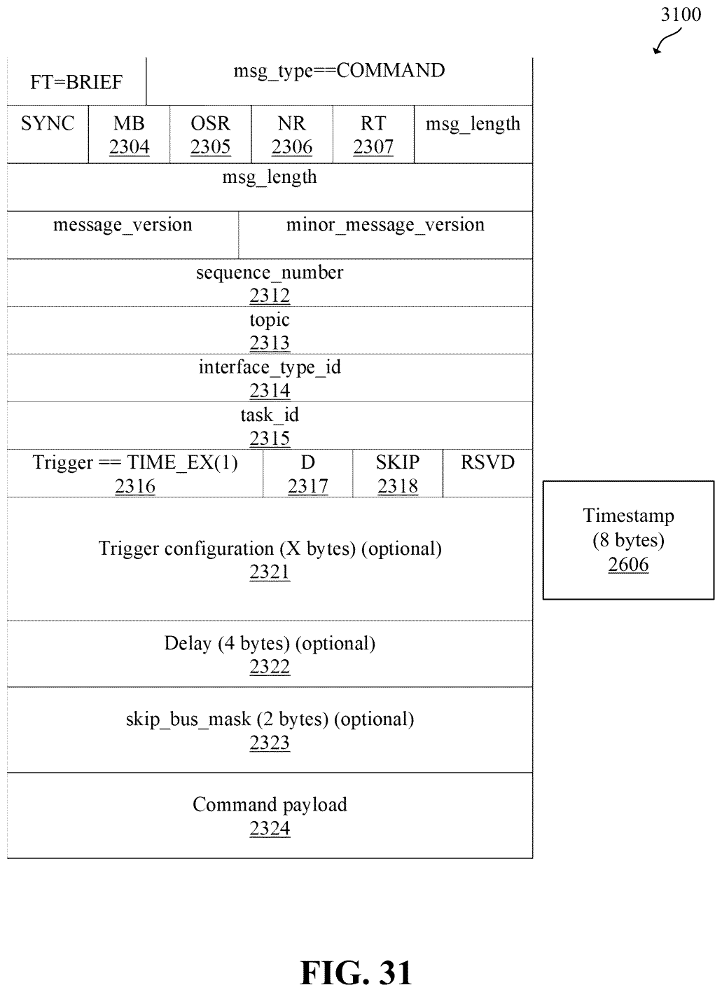

Referring to FIG. 31, exemplary trigger command settings 3100 on timestamp discard are shown, in accordance with an exemplary aspect.

Trigger configuration-On timestamp timebase 110A5

This functionality is designed to execute commands based on the formula “timestamp+n*timebase”. It is a trigger where a specific point in time (timestamp) servers as the reference, a fixed time interval (timebase) determines the periodicity, and an arbitrary multiplier (n) indicates when the trigger activates.

The trigger activation time is the point in time when the trigger becomes active for the first time.

timestamp: The timestamp field represents a specific point in time, and serves as the starting reference point for the trigger. The timestamp field includes two 32-bit variables: The first four bytes representing seconds and the last four bytes representing nanoseconds. Other units of times can be used.

timebase: The timebase field specifies a fixed interval of time, which determines the periodicity or frequency of the trigger's activation. This time is defined in nanoseconds and/or other time units.

The system searches for a multiple of (the reference time point plus the multiplier times the fixed time interval) to maintain synchronization.

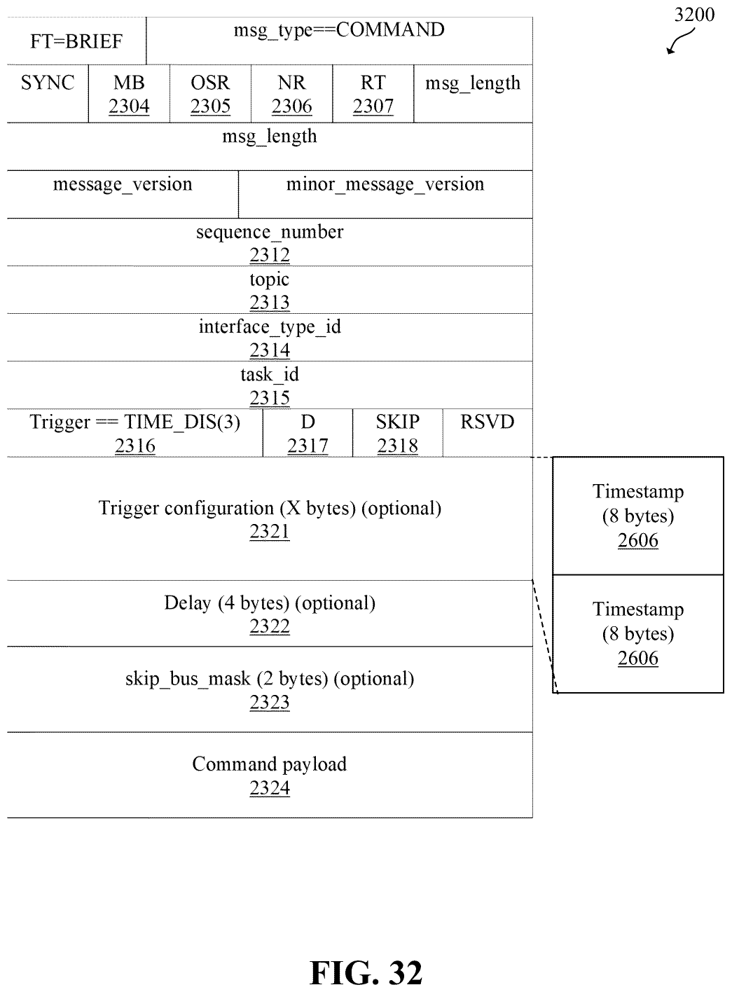

Referring to FIG. 32, exemplary trigger command settings 3200 on timestamp and timebase are shown, in accordance with an exemplary aspect.

### Trigger Configuration—Virtual Input—110A8, 110A9

The concept of a Virtual Inputs refers to an abstractions of IO interfaces, such as General Purpose Input/Output (GPIO) ports or other signal sources such as interrupts, timers, or internal buses. Virtualizing these signals means they can used by the interface trigger subsystem. For example, an internal virtual input connected to the safe mode of the device can be used to trigger the execution of a command, only when the system is in safe mode. The definition of the 24-bits Virtual Input bus is implementation specific.

op: This field determines the type of bitwise logical operation to be applied between the mask and the virtual input bus. It offers two modes:

AND Operation: In this mode, the output is true only if all the selected bits (as determined by the mask) in the virtual input bus are true (1). This operation is analogous to a series of interconnected switches, where every selected switch must be on for the circuit to activate.

OR Operation: In this mode, the output is true if any of the selected bits (as determined by the mask) in the virtual input bus are true (1). This is similar to having parallel switches, where activating any one of the selected switches turns on the circuit.

mask: The mask serves as a bit-wise selector that determines which bits in the virtual input bus are relevant for the logical operation.

AND operation: The mask singles out specific bits; the output is true only if all these selected bits are 1. If any of the selected bits is 0, the output will be false.

OR operation: The mask is used to identify certain bits; the output is true if at least one of these selected bits is 1. The output is false only if all the selected bits are 0.

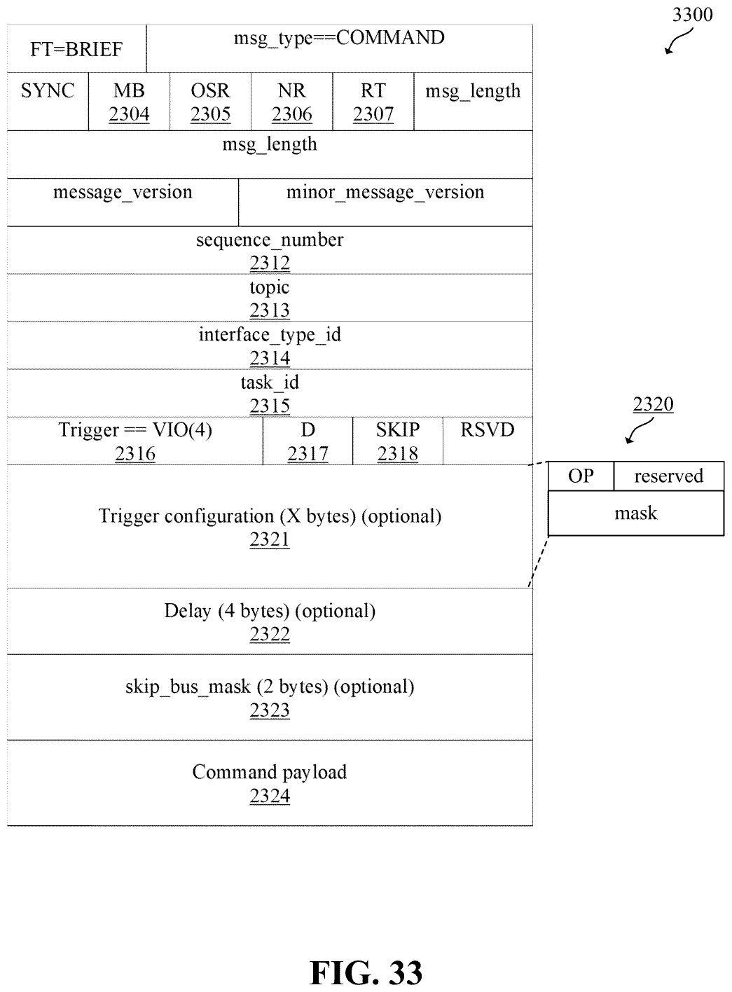

Referring to FIG. 33, exemplary trigger command settings 3300 on timestamp discard are shown, in accordance with an exemplary aspect.

### Trigger Configuration—On Command Start 110A10

Is a system designed to initiate actions based on specific command conditions. This configuration allows for the setting up of triggers that activate when certain commands are executed. Administrators can specify which conditions act as triggers and the system monitors for the execution and conditions for specified commands and, upon their detection, initiates the execution of the current message.

Each interface within the system has the capability to independently trigger the “On Command” functionality in response to a command. If multiple interfaces generate a response to one command, all responses are capable of triggering the “On Command” functionality.

OP: The OP field can have these values, each representing a different triggering condition for a command.

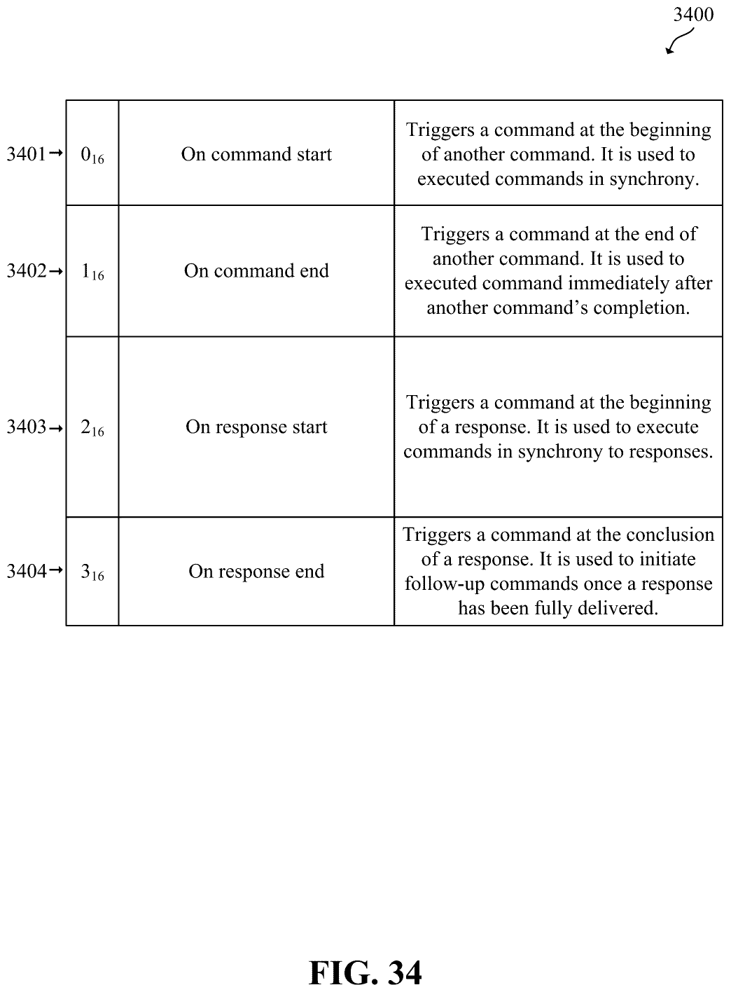

Referring to FIG. 34, exemplary op field values 3400 are shown for examples 3401 through 3404, in accordance with an exemplary aspect.

command_sequence_number: the command_sequence_number field specifies which command's sequence number that needs to be monitored for certain conditions (as defined by the op field values) to trigger the execution of the current command. That is, the command_sequence_number field specifies an identifier of a command sequence number (e.g., the command sequence number itself or an identifier of an applicable one of a plurality of potential command sequence numbers) used to execute the current command.

command_topic: This field specifies which command's topic that need to be monitored for certain conditions (as defined by the op field values) to trigger the execution of the current command.

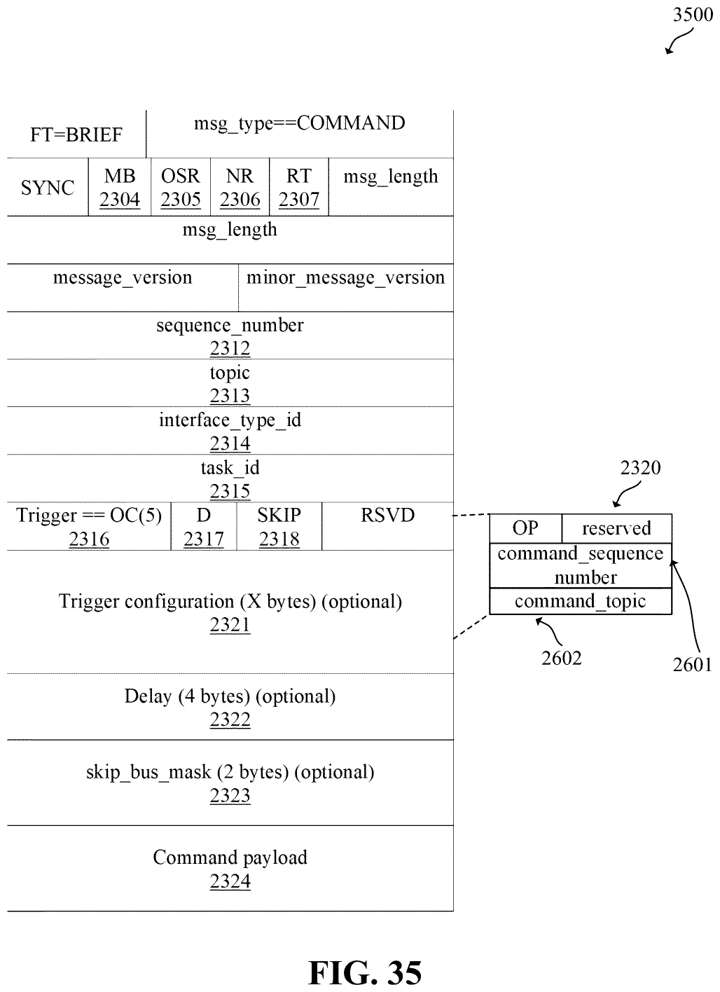

Referring to FIG. 35, exemplary trigger command settings 3500 on command are shown, in accordance with an exemplary aspect.

### Skip Configuration—110A14

The skip functionality is designed to control message processing using bit-wise masks and virtual skip buses. for each bus, “node_skip_bus” and “interface_skip_bus”, a mask specifies which bits to check. for each high bit in the mask, if the corresponding bit in a bus is high (1), the current message is skipped. if the bit is low (0), the message is processed. this allows for selective message handling at both the node and interface levels. the skip_bus_mask field is only available if the skip field is set to high (1).

The functionality of the node_skip_bus field is specific to each implementation and may include features such as safe modes, tailored to the particular requirements of the node operations.

Similarly, the interface_skip_bus field is also tailored to the specifics of each implementation, with additional considerations for the unique aspects of the interface it operates on. for instance, in an 12c interface, this could involve handling scenarios like a non-acknowledge signal.

When a message is skipped, the interface generates a message whose result field is set to skipped (5).

node_skip_bus_mask: a mask at the node level that determines message skipping based on a bit-wise mask, where a high bit results in the associated message being skipped.

interface_skip_bus_mask: a mask at the interface level that determines message skipping based on a bit-wise mask, where a high bit results in the associated message being skipped.

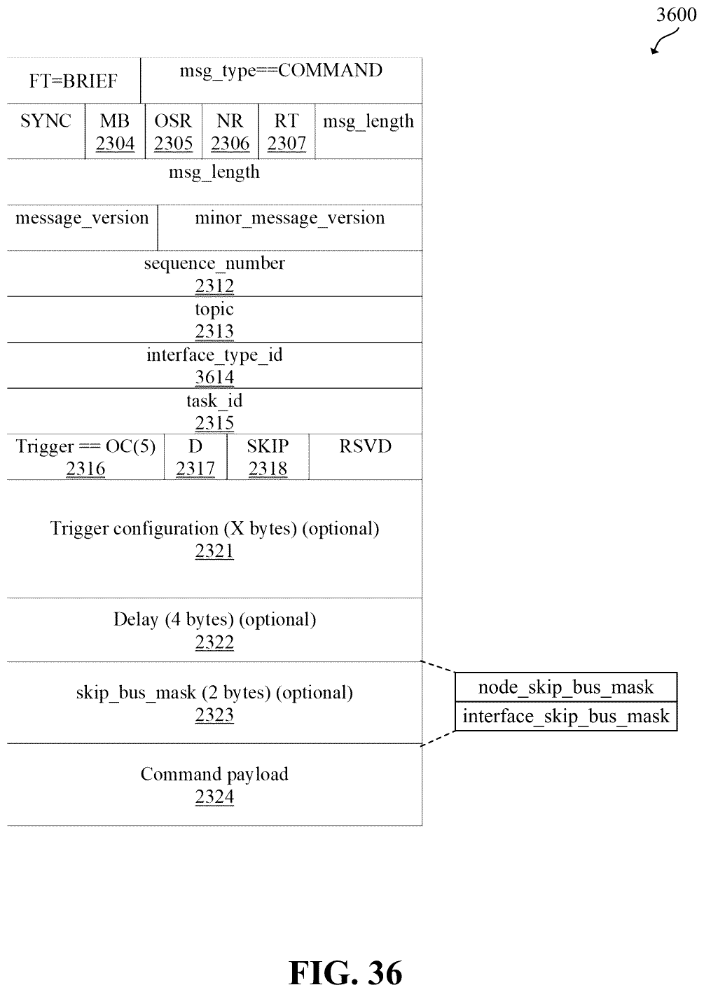

Referring to FIG. 36, exemplary trigger command settings 3600 on timestamp discard are shown, in accordance with an exemplary aspect.

A description of an example NOTIFICATION message will now be given.

### 0x09 NOTIFICATION Message Description

The notification message is designed to provide timely and relevant information to ECU's. It serves to alert and inform about various events, changes, or updates that occur within the remote node or interface. This message can cover a range of notifications, from critical system warnings to routine updates. The structure of the notification message contains all essential information for a system to consume the notification.

topic: Topics are indexed buses over which interfaces can publish messages. When an interface sends a message, it publishes on a topic. When a listener or ECU receives a message, it subscribes to a topic.

interface_type_id: The interface_type_id field includes the interface_type_id of the source of the notification. Together, with the notification_type_id field, the interface_type_id field helps to identify the schema of the notification.

notification_type_id: the notification_type_id field serves as a unique identifier for each notification type generated by an interface. Together, with interface_type_id helps to identify the schema of the notification.

MB: The MB field is designed to indicate the system that this notification is critical, requesting an acknowledge of the notification.

TV: The TV flag serves as an indicator of the presence of the associated timestamp field in the message. When set to a first value (e.g., true), the TV flag signifies that the timestamp is present and valid and accurately represents the time of the creation of the notification. Conversely, the TV flag being set to false implies that the timestamp is not present in the response.

timestamp: The timestamp field indicates the specific point in time until which the notification was created. The timestamp field includes two 32-bit variables: The first four bytes representing seconds and the last four bytes representing nanoseconds. The Timestamp field is an optional field that is only present if the TV flag is set to a first value (e.g., true).

payload: The payload field carries the actual content of the notification. The structure and data type of the payload field are determined by two key factors: the interface_type_id and the notification_type_id fields.

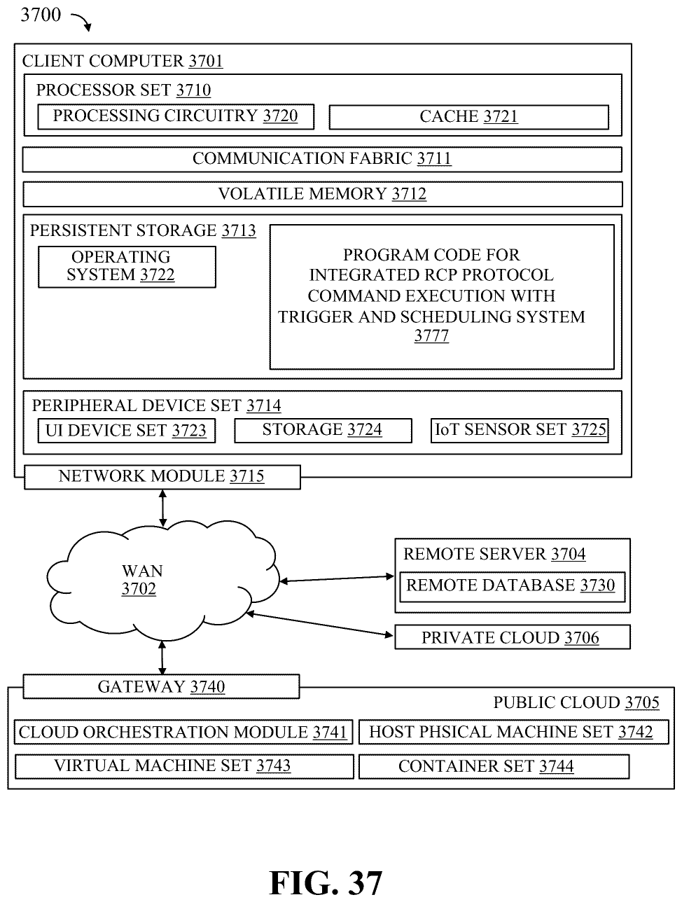

Referring to FIG. 37, an example computing environment 3700 is shown, in accordance with an exemplary aspect. Computing environment may be an in-car computing system having microphones and speakers as described.

Computing environment 3700 includes an example of an environment including a client computer 3701 configured for the execution of at least some of the program code 3777 involved in performing the methods described herein relating to integrated RCP protocol command execution with trigger and scheduling system in communication networks. The computing environment 3700, in addition to program code 3777, further includes for example, client computer 3701, wide area network (WAN) 3702, remote server 3704, public cloud 3705, and private cloud 3706. In this aspect, computer 3701 includes processor set 3710 (including processing circuitry 3720 and cache 3721), communication fabric 3711, volatile memory 3712, persistent storage 3713 (including operating system 3722 and program code 3777, as identified above), peripheral device set 3714 (including user interface (UI), device set 3723, storage 3724, and Internet of Things (IoT) sensor set 3725), and network module 3715. Remote server1 3704 includes remote database 3730. Public cloud 3705 includes gateway 3740, cloud orchestration module 3741, host physical machine set 3742, virtual machine set 3743, and container set 3744.

Computer 3701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 3730. Alternatively, performance of the computer-implemented method(s) described herein may be distributed among multiple computers and/or between multiple locations. For the sake of simplicity, in this presentation of computing environment 3700, the following detailed discussion is focused on a single computer, specifically computer 3701. Computer 3701 may be located in a cloud, even though computer 3701 is not shown in a cloud in FIG. 37. On the other hand, computer 3701 is not required to be in a cloud except to any extent as may be affirmatively indicated. Computer 3701 may be interchangeably referred to herein as “voice user interface (VUI)-based device” 3701.

Processor set 3710 includes one or more computer processors of any type. Processing circuitry 3720 may be distributed over multiple packages, for example, multiple, coordinated integrated circuit chips. Processing circuitry 3720 may implement multiple processor threads and/or multiple processor cores. Cache 3721 is memory that is located in the processor chip package(s) and is typically used for data or code that should be available for rapid access by the threads or cores running on processor set 3710. Cache memories are typically organized into multiple levels depending upon relative proximity to the processing circuitry. Alternatively, some, or all, of the cache for the processor set may be located “off chip.” In some computing environments, processor set 3710 may be designed for working with qubits and performing quantum computing.

Computer readable program instructions are typically loaded onto computer 3701 to cause a series of operational steps to be performed by processor set 3710 of computer 3701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 3721 and the other storage media discussed below. The program instructions, and associated data, are accessed by processor set 3710 to control and direct performance of the inventive methods. In computing environment 3700, at least some of the instructions for performing the inventive methods may be stored in program code 3777 in persistent storage 3713.

Communication fabric 3711 is the signal conduction paths that allow the various components of computer 3701 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 3712 is any type of volatile memory now known or to be developed in the future. Examples include dynamic type random access memory (RAM) or static type RAM. Typically, the volatile memory is characterized by random access, but this is not required unless affirmatively indicated. In computer 3701, the volatile memory 3712 is located in a single package and is internal to computer 3701, but, alternatively or additionally, the volatile memory may be distributed over multiple packages and/or located externally with respect to computer 3701. Relating to an online aspect, volatile memory 3712 may include a first buffer for collecting input samples and a second buffer for outputting the processed audio.

Persistent storage 3713 is any form of non-volatile storage for computers that is now known or to be developed in the future. The non-volatility of this storage means that the stored data is maintained regardless of whether power is being supplied to computer 3701 and/or directly to persistent storage 3713. Persistent storage 3713 may be a read only memory (ROM), but typically at least a portion of the persistent storage allows writing of data, deletion of data and re-writing of data. Some familiar forms of persistent storage include magnetic disks and solid state storage devices. Operating system 3722 may take several forms, such as various known proprietary operating systems or open source Portable Operating System Interface type operating systems that employ a kernel. The code included in program code 3777 typically includes at least some of the computer code involved in performing the inventive methods.

Peripheral device set 3714 includes the set of peripheral devices of computer 3701. Data communication connections between the peripheral devices and the other components of computer 3701 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various aspects, UI device set 3723 may include components such as one or more of a display screen, speaker or speaker array, microphone or microphone array, wearable devices (such as goggles and smart watches), keyboard, mouse, printer, touchpad, virtual reality goggles, augmented reality goggles, mixed reality goggles, game controllers, a voice user interface (VUI), an automatic speech recognition system (ASR), a text-to-speech (TTS) system, cameras, and haptic devices. Storage 3724 is external storage, such as an external hard drive, or insertable storage, such as an SD card. Storage 3724 may be persistent and/or volatile. In some aspects, storage 3724 may take the form of a quantum computing storage device for storing data in the form of qubits. In aspects where computer 3701 is required to have a large amount of storage (for example, where computer 3701 locally stores and manages a large database) then this storage may be provided by peripheral storage devices designed for storing very large amounts of data, such as a storage area network (SAN) that is shared by multiple, geographically distributed computers. IoT sensor set 3725 is made up of one or more sensors that can be used in Internet of Things applications. For example, one sensor may be a thermometer and another sensor may be a motion detector.

Further regarding peripheral device set 3714, the same is emphasized to include a set of cameras. In an aspect, the cameras are CCTV cameras. In an aspect, the cameras are doorbell cameras. In an aspect, the cameras are body-worn cameras. It is to be appreciated that the aspects of the present disclosure can be applied to any type of camera for which a human would be interested in knowing whether or not they are being recorded.

Network module 3715 is the collection of computer software, hardware, and firmware that allows computer 3701 to communicate with other computers through WAN 3702. Network module 3715 may include hardware, such as modems or Wi-Fi signal transceivers, software for packetizing and/or de-packetizing data for communication network transmission, and/or web browser software for communicating data over the internet. In some aspects, network control functions and network forwarding functions of network module 3715 are performed on the same physical hardware device. In other aspects (for example, aspects that utilize software-defined networking (SDN)), the control functions and the forwarding functions of network module 3715 are performed on physically separate devices, such that the control functions manage several different network hardware devices. Computer readable program instructions for performing the inventive methods can typically be downloaded to computer 3701 from an external computer or external storage device through a network adapter card or network interface included in network module 3715.

WAN 3702 is any wide area network (for example, the internet) capable of communicating computer data over non-local distances by any technology for communicating computer data, now known or to be developed in the future. In some aspects, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

Remote server 3704 is any computer system that serves at least some data and/or functionality to computer 3701. Remote server 3704 may be controlled and used by the same entity that operates computer 3701. Remote server 3704 represents the machine(s) that collect and store helpful and useful data for use by other computers, such as computer 3701.

Public cloud 3705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 3705 is performed by the computer hardware and/or software of cloud orchestration module 3741. The computing resources provided by public cloud 3705 are typically implemented by virtual computing environments that run on various computers making up the computers of host physical machine set 3742, which is the universe of physical computers in and/or available to public cloud 3705. The virtual computing environments (VCEs) typically take the form of virtual machines from virtual machine set 3743 and/or containers from container set 3744. It is understood that these VCEs may be stored as images and may be transferred among and between the various physical machine hosts, either as images or after instantiation of the VCE. Cloud orchestration module 3741 manages the transfer and storage of images, deploys new instantiations of VCEs and manages active instantiations of VCE deployments. Gateway 3740 is the collection of computer software, hardware, and firmware that allows public cloud 3705 to communicate through WAN 3702.

Public cloud 3705 may provide a subscription service for people interaction to a plurality of users such as a user of computer 3701. The service can have multiple purposes for people interaction. Such purposes for people interaction can include dating, friendship, and business.

In an aspect, public cloud 3705 operates in conjunction with remote server 3704 to enable profile information of users to be retrieved and provided to a user such as one using computer 3701 and/or another user operating a similar device as computer 2001.

Private cloud 3706 is similar to public cloud 3705, except that the computing resources are only available for use by a single enterprise. While private cloud 3706 is depicted as being in communication with WAN 3702, in other aspects a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this aspect, public cloud 3705 and private cloud 3706 are both part of a larger hybrid cloud.

Aspects of the present disclosure include one or any combination of the following clauses.
Clause 1. A communication method at a transmitting node of a communication system, comprising: configuring a header field of an information structure with one or more headers to control at least one of an execution of at least one command specified in the information structure or a delivery of a response to at least one of the execution of the at least one command or a receipt of the information structure; and transmitting a message including the header field.
Clause 2. The communication method in accordance with clause 1, further comprising: receiving a response message based on one of the one or more headers of the header field being configured to control the delivery of the response to the at least one of the execution of the at least one command or the receipt of the information structure.
Clause 3. The communication method in accordance with any preceding clauses, wherein configuring the header field of the information structure further comprises configuring the header field to include a delay header configured to include a time delay field specifying a time delay between command reception and command execution by a processing unit.
Clause 4. The communication method in accordance with any preceding clauses, wherein configuring the header field of the information structure further comprises configuring the header field to include a timeout header configured to identify a maximum time duration allowed between when the at least one command is queued for execution and when the at least one command is executed.
Clause 5. The communication method in accordance with any preceding clauses, further comprising: receiving a response message based on timeout header, wherein the response message comprises a result field having a value indicating a timeout corresponding to the at least one command being unexecuted at an end of the maximum time duration.
Clause 6. The communication method in accordance with any preceding clauses, wherein configuring the header field of the information structure further comprises configuring the header field to include an on_timestamp_execute header configured to include at least one field specifying a timestamp based execution time at which the at least one command is to be executed.
Clause 7. The communication method in accordance with any preceding clauses, wherein configuring the header field of the information structure further comprises configuring the header field to include an on_timestamp_discard header configured to include at least one field specifying an execution time at which the at least one command is to be executed, wherein the at least one command is configured to be executed at the execution time or to be discarded when the execution time is a past time.
Clause 8. The communication method in accordance with any preceding clauses, wherein configuring the header field of the information structure further comprises configuring the header field to include an on_timestamp_timebase header having a timestamp field, a timebase field, and a multiplier field, wherein the on_timestamp_timebase header is configured to cause execution of the at least one command as a function of the timestamp field, the timebase field, and the multiplier field, wherein the timestamp field specifies a reference time point, the timebase field specifies a fixed time interval, and the multiplier field specifies a multiplier, and wherein the method further comprises searching for a multiple of (the reference time point plus the multiplier times the fixed time interval) to maintain synchronization.
Clause 9. The communication method in accordance with any preceding clauses, wherein configuring the header field of the information structure further comprises configuring the header field to include a repeat header configured to control an automatic repetition of an execution of the at least one command, wherein the repeat header includes a count field indicating a number of times the at least one command is to be repeated.
Clause 10. The communication method in accordance with any preceding clauses, wherein configuring the header field of the information structure further comprises configuring the count field to have a value of 0 to specify an infinite number of execution repeats until the at least one command is cancelled.
Clause 11. The communication method in accordance with any preceding clauses, wherein configuring the header field of the information structure further comprises configuring the repeat header to include a rearm_delay field that sets a command rearm delay time.
Clause 12. The communication method in accordance with any preceding clauses, wherein configuring the header field of the information structure further comprises configuring the header field to include a request_timestamp header configured to specify whether the response to the at least one command is to include a timestamp indicating a time when the response was generated.
Clause 13. The communication method in accordance with any preceding clauses, wherein configuring the header field of the information structure further comprises configuring the header field to include an on_virtual_io_and header configured to provide an output on a virtual input bus for a logical and operation based on mask-selected bits in a mask field of the on_virtual_io_and header, wherein the at least one command is executed when all of the bits in the mask field of the on_virtual_io_and header have a predetermined value.
Clause 14. The communication method in accordance with any preceding clauses, wherein configuring the header field of the information structure further comprises configuring the header field to include an on_virtual_io_or header configured to provide an output on a virtual input bus for a logical or operation based on one or more bits in a mask field of the on_virtual_io_or header, wherein the at least one command is executed when at least one of the one or more bits in the mask field of the on_virtual_io_or header has a predetermined value.
Clause 15. The communication method in accordance with any preceding clauses, wherein configuring the header field of the information structure further comprises configuring the header field to include an on_command_start header configured to indicate that the at least one command is executed at a beginning of executing another command.
Clause 16. The communication method in accordance with any preceding clauses, wherein configuring the header field of the information structure further comprises configuring the header field to include an on_command_end header configured to indicate that the at least one command is executed at an end of executing another command.
Clause 17. The communication method in accordance with any preceding clauses, wherein configuring the header field of the information structure further comprises configuring the header field to include an on_response_start header configured to indicate that the at least one command triggers an execution of at least one other command at a beginning of the response to the at least one command.
Clause 18. The communication method in accordance with any preceding clauses, wherein configuring the header field of the information structure further comprises configuring a command_controller_id field which identifies an identifier of a controller used to execute the at least one other command.
Clause 19. The communication method in accordance with any preceding clauses, wherein configuring the header field of the information structure further comprises configuring a command_operation_id field which identifies an identifier of an operation used to execute the at least one other command.
Clause 20. The communication method in accordance with any preceding clauses, wherein configuring the header field of the information structure further comprises configuring the header field to include an on_response_end header configured to indicate that the at least one command triggers an execution of at least one other command at a conclusion of the response to the at least one command.
Clause 21. The communication method in accordance with any preceding clauses, wherein configuring the header field of the information structure further comprises configuring a command_controller_id field which identifies a controller used to execute the at least one other command.
Clause 22. The communication method in accordance with any preceding clauses, wherein configuring the header field of the information structure further comprises configuring a command_operation_id field which identifies an operation used to execute the at least one other command.
Clause 23. The communication method in accordance with any preceding clauses, wherein configuring the header field of the information structure further comprises configuring the header field to include a skip header configured to indicate conditional command execution based on a status of a node.
Clause 24. The communication method in accordance with any preceding clauses, wherein the SKIP header is configured to indicate the conditional command execution using at least one bit-wise mask and at least one virtual skip bus, wherein for each virtual skip bus, in a node_skip_bus field and an interface_skip_bus field, a respective bit-wise mask specifies which bits to check, wherein for each bit of a given value in the bit-wise mask, if a corresponding bit in the virtual skip bus is a first value, the at least one command is skipped and if the corresponding bit in the virtual skip bus is a second value, the at least one command is executed.
Clause 25. The communication method in accordance with any preceding clauses, wherein configuring the header field of the information structure further comprises configuring the node_skip_bus field to include at least one bit indicating whether to skip or execute the at least one command.
Clause 26. The communication method in accordance with any preceding clauses, wherein the node_skip_bus field is configured to operate at a node level to determine message skipping based on values in a respective bit-wise mask, where a respective bit in the bit-wise mask having a first value results in an associated message being skipped.
Clause 27. the communication method in accordance with any preceding clauses, wherein the node_skip_bus field includes at least one flag comprising at least one of a time synchronization locked flag, a safety mode active flag, or a safety mode not-active flag.
Clause 28. The communication method in accordance with any preceding clauses, wherein the interface_skip_bus field is configured to operate at an interface level to determine command skipping based on values in a bit-wise mask, where a high bit results in an associated command being skipped.
Clause 29. The communication method in accordance with any preceding clauses, wherein the interface_skip_bus field includes at least one flag comprising at least one of a device acknowledge flag, a device non-acknowledge flag, a data acknowledge flag, or a data non-acknowledge flag.
Clause 30. The communication method in accordance with any preceding clauses, wherein configuring the header field of the information structure further comprises configuring the header field to include an on_start_response header configured to specify whether an interface is to produce the response without any content at a commencement of an execution of the at least one command.
Clause 31. The communication method in accordance with any preceding clauses, wherein the on_start_response header is configured to cause a subsequent response to be sent without data upon command execution commencement or the subsequent response to be sent with data upon command execution completion.
Clause 32. The communication method in accordance with any preceding clauses, wherein configuring the header field of the information structure further comprises configuring the header field to include a metadata header configured to cause inclusion of a payload field in the response, wherein a length field specifies a length of a metadata payload, and wherein the payload field indicates that the response is to include metadata information.
Clause 33. The communication method in accordance with clause 1, wherein configuring the header field of the information structure further comprises configuring the header field to include a no_response header configured to indicate that the response is to be omitted.
Clause 34. The communication method in accordance with clause 1, wherein configuring the header field of the information structure further comprises configuring the header field to include a cancel_command header configured to indicate to cancel a previously sent command.
Clause 35. A non-transitory computer-readable device having instructions thereon that, when executed by at least one computing device, causes the at least one computing device to perform operations comprising: configuring a header field of an information structure to control at least one of an execution of at least one command specified in the information structure and a delivery of a response to at least one of the execution of the at least one command and a receipt of the information structure; and transmitting a message including the header field.
Clause 36. A communication method at a receiving node of a communication system, comprising: receiving a message including a header field of an information structure configured with one or more headers to control at least one of an execution of at least one command specified in the information structure or a delivery of a response to at least one of the execution of the at least one command or a receipt of the information structure.
Clause 37. The communication method in accordance with clause 36, further comprising: transmitting a response message based on one of the one or more headers of the header field being configured to control the delivery of the response to the at least one of the execution of the at least one command or the receipt of the information structure.
Clause 38. The communication method in accordance with any preceding clauses, wherein the header field of the information structure is configured to include a DELAY header, wherein the DELAY header is configured to include a time delay field specifying a time delay between command reception and command execution by a processing unit.
Clause 39. The communication method in accordance with any preceding clauses, wherein the header field of the information structure is configured to include a timeout header, wherein the timeout header is configured to identify a maximum time duration allowed between when the at least one command is queued for execution and when the at least one command is executed.
Clause 40. The communication method in accordance with any preceding clauses, wherein the header field of the information structure is configured to include an on_timestamp_execute header, wherein the on_timestamp_execute header is configured to include at least one field specifying a timestamp based execution time, wherein the at least one command is executed when the timestamp based execution time is a past time.
Clause 41. The communication method in accordance with any preceding clauses, wherein the header field of the information structure is configured to include an on_timestamp_discard header, wherein the on_timestamp_discard header is configured to include at least one field specifying an execution time at which the at least one command is to be executed, wherein the at least one command is configured to be executed at the execution time or to be discarded when the execution time is a past time.
Clause 42. The communication method in accordance with any preceding clauses, wherein the header field of the information structure is configured to include an on_timestamp_timebase header having a timestamp field, a timebase field, and a multiplier field, wherein the on_timestamp_timebase header is configured to cause execution of the at least one command as a function of the timestamp field, the timebase field, and the multiplier field, wherein the timestamp field specifies a reference time point, the timebase field specifies a fixed time interval, and the multiplier field specifies a multiplier, and wherein the method further comprises searching for a multiple of (the reference time point plus the multiplier times the fixed time interval) to maintain synchronization.
Clause 43. The communication method in accordance with any preceding clauses, wherein the header field of the information structure is configured to include a repeat header, wherein the repeat header is configured to control an automatic repetition of an execution of the at least one command, wherein the repeat header includes a count field indicating a number of times the at least one command is to be repeated.
Clause 44. The communication method in accordance with any preceding clauses, wherein the header field of the information structure is configured to include a request_timestamp header, wherein the request_timestamp header is configured to specify whether the response to the at least one command is to include a timestamp indicating a time when the response was generated.
Clause 45. The communication method in accordance with any preceding clauses, wherein the header field of the information structure is configured to include an on_virtual_io_and header, wherein the on_virtual_io_and header is configured to provide an output on a virtual input bus for a logical and operation based on bits in a mask field of the on_virtual_io_and header, wherein the at least one command is executed when all of the bits in the mask field of the on_virtual_io_and header have a predetermined value.
Clause 46. The communication method in accordance with any preceding clauses, wherein the header field of the information structure is configured to include an on_virtual_io_or header, wherein the on_virtual_io_or header is configured to provide an output on a virtual input bus for a logical or operation based on one or more bits in a mask field of the on_virtual_io_or header, wherein the at least one command is executed when at least one of the one or more bits in the mask field of the on_virtual_io_or header has a predetermined value.
Clause 47. The communication method in accordance with any preceding clauses, wherein the header field of the information structure is configured to include an on_command_start header, wherein the on_command_start header is configured to indicate that the at least one command is executed at a beginning of executing another command.
Clause 48. The communication method in accordance with any preceding clauses, wherein the header field of the information structure is configured to include an on_command_end header, wherein the on_command_end header is configured to indicate that the at least one command is executed at an end of executing another command.
Clause 49. The communication method in accordance with any preceding clauses, wherein the header field of the information structure is configured to include an on_response_start header, wherein the on_response_start header is configured to indicate that the at least one command triggers an execution of at least one other command at a beginning of the response to the at least one command.
Clause 50. The communication method in accordance with any preceding clauses, wherein the header field of the information structure is configured to include an on_response_end header, wherein the on_response_end header is configured to indicate that the at least one command triggers an execution of at least one other command at a conclusion of the response to the at least one command.
Clause 51. The communication method in accordance with any preceding clauses, wherein the header field of the information structure is configured to include a skip header, wherein the skip header is configured to indicate conditional command execution based on a status of a node.
Clause 52. The communication method in accordance with any preceding clauses, wherein the header field of the information structure is configured to include an on_start_response header, wherein the on_start_response header is configured to specify whether an interface is to produce the response without any content at a commencement of an execution of the at least one command.
Clause 53. The communication method in accordance with any preceding clauses, wherein the header field of the information structure is configured to include a metadata header, wherein the metadata header is configured to cause inclusion of a payload field in the response, wherein a length field specifies a length of a metadata payload, and wherein the payload field indicates that the response is to include metadata information.
Clause 54. The communication method in accordance with any preceding clauses, wherein the header field of the information structure is configured to include a no_response header, wherein the no_response header is configured to indicate that the response is to be omitted.
Clause 55. The communication method in accordance with any preceding clauses, wherein the header field of the information structure is configured to include a cancel_command header, wherein the cancel_command header is configured to indicate to cancel a previously sent command.
Clause 56. A non-transitory computer-readable device having instructions thereon that, when executed by at least one computing device, causes the at least one computing device to perform operations comprising: receiving a message including a header field of an information structure configured with one or more headers to control at least one of an execution of at least one command specified in the information structure or a delivery of a response to at least one of the execution of the at least one command or a receipt of the information structure.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

Various aspects of the disclosure may take the form of an entirely or partially hardware aspect, an entirely or partially software aspect, or a combination of software and hardware. Furthermore, as described herein, various aspects of the disclosure (e.g., systems and methods) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit the performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read-only memory (ROM); random access memory (RAM); magnetic disk storage media; optical storage media; flash memory, and so forth.

Aspects of this disclosure are described herein with reference to block diagrams and flowchart illustrations of methods, systems, apparatuses, and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general-purpose computer, a special-purpose computer, or another programmable information processing apparatus to produce a particular machine, such that the operations or functions specified in the flowchart block or blocks can be implemented in response to execution at the computer or processing apparatus.

Unless otherwise expressly stated, it is in no way intended that any device protocol, procedure, process, or method set forth herein be construed as requiring that its acts or steps be performed in a specific order. Accordingly, where a process or method claim does not actually recite an order to be followed by its acts or steps, or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to the arrangement of steps or operational flow; plain meaning derived from grammatical organization or punctuation; the number or type of aspects described in the specification or annexed drawings; or the like.

As used in this disclosure, including the annexed drawings, the terms “component,” “module,” “system,” and the like are intended to refer to a computer-related entity or an entity related to an apparatus with one or more specific functionalities. The entity can be either hardware, a combination of hardware and software, software, or software in execution. One or more of such entities are also referred to as “functional elements.” As an example, a component can be a process running on a processor, a processor, an object, an executable, a thread of execution, a program, and/or a computer. For example, both an application running on a server or network controller, and the server or network controller can be a component. One or more components can reside within a process and/or thread of execution and a component can be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which parts can be controlled or otherwise operated by program code executed by a processor. As yet another example, a component can be an apparatus that provides specific functionality through electronic components without mechanical parts, the electronic components can include a processor to execute program code that provides, at least partially, the functionality of the electronic components. As still another example, interface(s) can include I/O components or Application Programming Interface (API) components. While the foregoing examples are directed to aspects of a component, the exemplified aspects or features also apply to a system, module, and similar.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should be construed to mean “one or more” unless specified otherwise or clear from context to be directed to a singular form.

In addition, the terms “example” and “such as” and “e.g.” are utilized herein to mean serving as an instance or illustration. Any aspect or design described herein as an “example” or referred to in connection with a “such as” clause or “e.g.” is not necessarily to be construed as preferred or advantageous over other aspects or designs described herein. Rather, use of the terms “example” or “such as” or “e.g.” is intended to present concepts in a concrete fashion. The terms “first,” “second,” “third,” and so forth, as used in the claims and description, unless otherwise clear by context, is for clarity only and does not necessarily indicate or imply any order in time or space.

The term “processor,” as utilized in this disclosure, can refer to any computing processing unit or device comprising processing circuitry that can operate on data and/or signaling. A computing processing unit or device can include, for example, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. In some cases, processors can exploit nano-scale architectures, such as molecular and quantum-dot based transistors, switches and gates, in order to optimize space usage or enhance performance of user equipment. A processor may also be implemented as a combination of computing processing units.

In addition, terms such as “store,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. Moreover, a memory component can be removable or affixed to a functional element (e.g., device, server).

Simply as an illustration, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Various aspects described herein can be implemented as a method, apparatus, or article of manufacture using special programming as described herein. In addition, various of the aspects disclosed herein also can be implemented by means of program modules or other types of computer program instructions specially configured as described herein and stored in a memory device and executed individually or in combination by one or more processors, or other combination of hardware and software, or hardware and firmware. Such specially configured program modules or computer program instructions, as described herein, can be loaded onto a general-purpose computer, a special-purpose computer, or another type of programmable data processing apparatus to produce a machine, such that the instructions which execute on the computer or other programmable data processing apparatus create a means for implementing the functionality of disclosed herein.

The term “article of manufacture” as used herein is intended to encompass a computer program accessible from any non-transitory computer-readable device, carrier, or media. For example, computer readable media can include but are not limited to magnetic storage devices (e.g., hard drive disk, floppy disk, magnetic strips, or similar), optical discs (e.g., compact disc (CD), digital versatile disc (DVD), blu-ray disc (BD), or similar), smart cards, and flash memory devices (e.g., card, stick, key drive, or similar).

The detailed description set forth herein in connection with the annexed figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well-known components are shown in block diagram form, while some blocks may be representative of one or more well-known components.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A communication method at a receiving node of a communication system, comprising:
receiving a message including a header field of an information structure configured with one or more headers to control at least one of an execution of at least one command specified in the information structure or a delivery of a response to at least one of the execution of the at least one command or a receipt of the information structure.

2. The communication method in accordance with claim 1, further comprising:
transmitting a response message based on one of the one or more headers of the header field being configured to control the delivery of the response to the at least one of the execution of the at least one command or the receipt of the information structure.

3. The communication method in accordance with claim 1, wherein the header field of the information structure is configured to include a DELAY header, wherein the DELAY header is configured to include a time delay field specifying a time delay between command reception and command execution by a processing unit.

4. The communication method in accordance with claim 1, wherein the header field of the information structure is configured to include a timeout header, wherein the timeout header is configured to identify a maximum time duration allowed between when the at least one command is queued for execution and when the at least one command is executed.

5. The communication method in accordance with claim 1, wherein the header field of the information structure is configured to include an on_timestamp_execute header, wherein the on_timestamp_execute header is configured to include at least one field specifying a timestamp based execution time, wherein the at least one command is executed when the timestamp based execution time is a past time.

6. The communication method in accordance with claim 1, wherein the header field of the information structure is configured to include an on_timestamp_discard header, wherein the on_timestamp_discard header is configured to include at least one field specifying an execution time at which the at least one command is to be executed, wherein the at least one command is configured to be executed at the execution time or to be discarded when the execution time is a past time.

7. The communication method in accordance with claim 1, wherein the header field of the information structure is configured to include an on_timestamp_timebase header having a timestamp field, a timebase field, and a multiplier field, wherein the on_timestamp_timebase header is configured to cause execution of the at least one command as a function of the timestamp field, the timebase field, and the multiplier field, wherein the timestamp field specifies a reference time point, the timebase field specifies a fixed time interval, and the multiplier field specifies a multiplier, and wherein the method further comprises searching for a multiple of (the reference time point plus the multiplier times the fixed time interval) to maintain synchronization.

8. The communication method in accordance with claim 1, wherein the header field of the information structure is configured to include a repeat header, wherein the repeat header is configured to control an automatic repetition of an execution of the at least one command, wherein the repeat header includes a count field indicating a number of times the at least one command is to be repeated.

9. The communication method in accordance with claim 1, wherein the header field of the information structure is configured to include a request_timestamp header, wherein the request_timestamp header is configured to specify whether the response to the at least one command is to include a timestamp indicating a time when the response was generated.

10. The communication method in accordance with claim 1, wherein the header field of the information structure is configured to include an on_virtual_io_and header, wherein the on_virtual_io_and header is configured to provide an output on a virtual input bus for a logical and operation based on bits in a mask field of the on_virtual_io_and header, wherein the at least one command is executed when all of the bits in the mask field of the on_virtual_io_and header have a predetermined value.

11. The communication method in accordance with claim 1, wherein the header field of the information structure is configured to include an on_virtual_io_or header, wherein the on_virtual_io_or header is configured to provide an output on a virtual input bus for a logical or operation based on one or more bits in a mask field of the on_virtual_io_or header, wherein the at least one command is executed when at least one of the one or more bits in the mask field of the on_virtual_io_or header has a predetermined value.

12. The communication method in accordance with claim 1, wherein the header field of the information structure is configured to include an on_command_start header, wherein the on_command_start header is configured to indicate that the at least one command is executed at a beginning of executing another command.

13. The communication method in accordance with claim 1, wherein the header field of the information structure is configured to include an on_command_end header, wherein the on_command_end header is configured to indicate that the at least one command is executed at an end of executing another command.

14. The communication method in accordance with claim 1, wherein the header field of the information structure is configured to include an on_response_start header, wherein the on_response_start header is configured to indicate that the at least one command triggers an execution of at least one other command at a beginning of the response to the at least one command.

15. The communication method in accordance with claim 1, wherein the header field of the information structure is configured to include an on_response_end header, wherein the on_response_end header is configured to indicate that the at least one command triggers an execution of at least one other command at a conclusion of the response to the at least one command.

16. The communication method in accordance with claim 1, wherein the header field of the information structure is configured to include a skip header, wherein the skip header is configured to indicate conditional command execution based on a status of a node.

17. The communication method in accordance with claim 1, wherein the header field of the information structure is configured to include an on_start_response header, wherein the on_start_response header is configured to specify whether an interface is to produce the response without any content at a commencement of an execution of the at least one command.

18. The communication method in accordance with claim 1, wherein the header field of the information structure is configured to include a metadata header, wherein the metadata header is configured to cause inclusion of a payload field in the response, wherein a length field specifies a length of a metadata payload, and wherein the payload field indicates that the response is to include metadata information.

19. The communication method in accordance with claim 1, wherein the header field of the information structure is configured to include a no_response header, wherein the no_response header is configured to indicate that the response is to be omitted.

20. The communication method in accordance with claim 1, wherein the header field of the information structure is configured to include a cancel_command header, wherein the cancel_command header is configured to indicate to cancel a previously sent command.

21. A non-transitory computer-readable device having instructions thereon that, when executed by at least one computing device, causes the at least one computing device to perform operations comprising:
receiving a message including a header field of an information structure configured with one or more headers to control at least one of an execution of at least one command specified in the information structure or a delivery of a response to at least one of the execution of the at least one command or a receipt of the information structure.
